(19) United States
(12) Patent Application Publication
(10) Pub. No.: US 2026/0054489 A1
(43) Pub. Date: Feb. 26, 2026

(54) INK REPLENISHMENT CONTAINER

(71) Applicant: SEIKO EPSON CORPORATION, Tokyo (JP)

(72) Inventors: Tadahiro MIZUTANI, Shiojiri-shi (JP); Tadashi Watanabe, Matsumoto-shi (JP); Yuta Koike, Matsumoto-shi (JP); Shun Oya, Kiso-machi (JP); Atsushi Kobayashi, Matsumoto-shi (JP)

(73) Assignee: SEIKO EPSON CORPORATION, Tokyo (JP)

(21) Appl. No.: 19/306,611

(22) Filed: Aug. 21, 2025

(30) Foreign Application Priority Data
Aug. 22, 2024 (JP) 2024-140666
Dec. 26, 2024 (JP) 2024-229929

(51) Int. Cl. B41J 2/175

(52) U.S. Cl. CPC B41J 2/17509; B41J 2/17523; B41J 2/1754; B41J 2/17553; B41J 2/17596

(57) ABSTRACT

An ink replenishment container includes a container main body portion, an ink outlet-forming portion, a cap, a first valve disposed inside the ink outlet-forming portion to control a communication state of an internal flow path, and a second valve disposed in at least one of an inside including an outlet of the ink outlet-forming portion and an inside of the cap, and positioned between an ink accommodation chamber and an outlet sealing portion, in which the second valve is a differential pressure valve that is opened when a pressure difference between a pressure in a space on the ink accommodation chamber side of the second valve and a pressure in a space on an outlet sealing portion side of the second valve is equal to or greater than a predetermined value.

The present application is based on, and claims priority from JP Application Serial Number 2024-229929, filed Dec. 26, 2024 and JP Application Serial Number 2024-140666, filed Aug. 22, 2024, the disclosures of which are hereby incorporated by reference herein in their entirety.

### BACKGROUND

### 1. Technical Field

The present disclosure relates to an ink replenishment container.

### 2. Related Art

In the related art, as an example of an ink ejecting apparatus, a printer that performs printing on a printing medium, such as printing paper, with ink by ejecting the ink from a print head toward the printing medium is known. Such a printer includes an ink replenishment-type printer for replenishing ink to an ink tank. JP-A-2023-51714 discloses an ink replenishment container used for replenishing ink to an ink replenishment-type ink tank.

In the technology of JP-A-2023-51714, an ink replenishment container is disclosed in which a valve using a spring member is disposed inside an ink outlet. In a valve closed state, the spring member biases a valve body toward a sealing member, so that the valve body comes into contact with the sealing member. As a result, when a through-hole of the sealing member is closed by the valve body, a fluid flow path that provides communication between a container main body and the ink outlet is blocked. When the ink replenishment container is mounted on the printer, an ink introduction member of the printer presses the valve body in a direction away from the sealing member. Therefore, the valve is in an open state due to separation of the valve body from the sealing member, and the ink is replenished from the ink replenishment container to the printer via the ink introduction member. In addition, in the technology of JP-A-2023-51714, the ink replenishment container includes a cap having a protrusion. The inner peripheral surface of the cap and the outer peripheral surface of the ink outlet-forming portion of the ink replenishment container are formed with screws for screwing the inner peripheral surface and the outer peripheral surface together. In a state where the cap is closed to the ink outlet-forming portion and completes the mounting of the cap on the ink outlet-forming portion, the protrusion presses the valve body in the direction away from the sealing member so that the valve maintains the open state.

In the related art, when an opening operation of the cap is performed in a case where the ink replenishment container is in a posture different from an upright posture, such as a posture in which the ink outlet is turned sideways or a posture in which the ink outlet is disposed in a direction having a downward component, the ink in the container main body may flow out into the cap via the valve in the open state. When the ink flows out into the cap, a problem may occur such as ink stain, in which user's hands performing the opening operation of the cap are stained with the ink or the ink drips onto the surrounding area and the surrounding area is stained with the ink.

### SUMMARY

According to an aspect of the present disclosure, there is provided an ink replenishment container for replenishing ink to a printer via an ink introduction member disposed in the printer. The ink replenishment container includes: a container main body portion having an ink accommodation chamber; an ink outlet-forming portion having an outlet facing an outside, the ink outlet-forming portion connected to the container main body portion and having an internal flow path that provides fluid communication between the outlet and the ink accommodation chamber; a cap having an outlet sealing portion that seals the outlet by being engaged with the ink outlet-forming portion; a first valve disposed inside the ink outlet-forming portion to control a communication state of the internal flow path, the first valve being closed as being biased by an elastic member in a first direction from an ink accommodation chamber side toward the outlet and being opened by the ink introduction member that is inserted from the outlet in a second direction opposite to the first direction against the biasing; and a second valve disposed in at least one of an inside of the ink outlet-forming portion including the outlet and an inside of the cap, the second valve being positioned between the ink accommodation chamber and the outlet sealing portion, in which the second valve is a differential pressure valve that is opened when a pressure difference between a pressure in a space on the ink accommodation chamber side of the second valve and a pressure in a space on an outlet sealing portion side of the second valve is equal to or greater than a predetermined value.

### BRIEF DESCRIPTION OF THE DRAWINGS

FIG. 1 is a perspective view of a printer according to a first embodiment.

FIG. 2 is a perspective view illustrating a state where ink is replenished to an ink tank by using an ink replenishment container.

FIG. 3 is an exploded perspective view of the ink replenishment container according to the embodiment.

FIG. 4 is a first perspective view of a first valve.

FIG. 5 is a second perspective view of the first valve.

FIG. 6 is a view of the ink replenishment container as seen from an outlet side.

FIG. 7 is a perspective view of the ink tank of the embodiment.

FIG. 8 is a view illustrating a state where the ink is replenished from the ink replenishment container to the ink tank.

FIG. 9 is a view for further explaining the ink replenishment container.

FIG. 10 is a partial cross-sectional view illustrating the ink replenishment container at a first timing of a release process.

FIG. 11 is a partial cross-sectional view illustrating the ink replenishment container at a second timing of the release process.

FIG. 12 is a first partial cross-sectional view of the ink replenishment container in a released state.

FIG. 13 is a second partial cross-sectional view of the ink replenishment container in the released state.

FIG. 14 is a view for explaining an opening/closing operation of a second valve.

FIG. 15 is a view for explaining an ink replenishment container of a second embodiment.

FIG. 16 is a view for explaining an ink replenishment container of a third embodiment.

FIG. 17 is a view for explaining an ink replenishment container of a fourth embodiment.

FIG. 18 is a view for explaining an ink replenishment container of a fifth embodiment.

### DESCRIPTION OF EMBODIMENTS

### A. First Embodiment

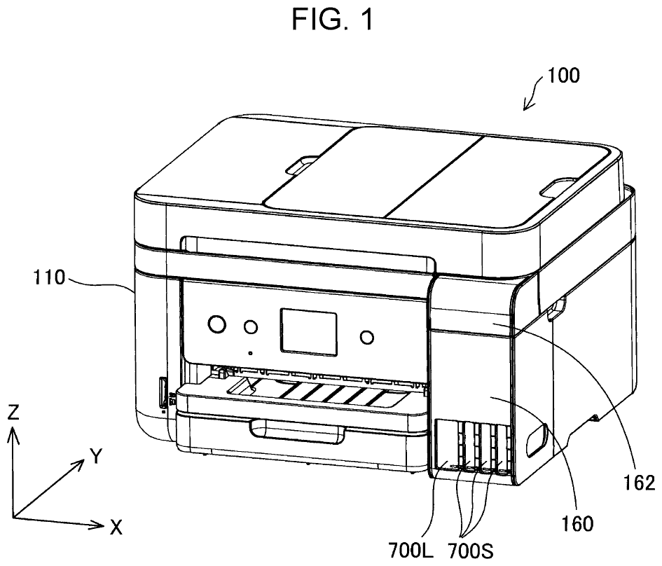

FIG. 1 is a perspective view of a printer 100 according to a first embodiment. The printer 100 is an ink jet printer that performs printing by ejecting ink onto a printing medium. In FIG. 1, XYZ axes orthogonal to each other are illustrated. The X axis corresponds to a width direction of the printer 100, the Y axis corresponds to a front/rear direction of the printer 100, and the Z axis corresponds to a height direction of the printer 100. The printer 100 is installed on a horizontal installation surface defined by an X direction and a Y direction. The “X direction” means a concept in which a +X direction and a −X direction are combined. Similarly, the “Y direction” means a concept in which the +Y direction and the −Y direction are combined, and the “Z direction” is a vertical direction, and means a concept in which the +Z direction, which is a vertical upward direction, and the −Z direction, which is a vertical downward direction, are combined.

The printer 100 includes a housing 110. A carriage (not illustrated) that is movable in a main scanning direction, which is the X direction, is provided inside the housing 110. A print head that ejects ink onto a printing medium is installed in the carriage. An ink tank accommodation unit 160 that accommodates a plurality of ink tanks 700S and 700L is provided at one end of a front surface of the housing 110. The ink tank accommodation unit 160 includes an openable/closable lid 162 at an upper portion thereof. The ink tanks 700S are small-capacity tanks, and the ink tank 700L is a large-capacity tank. Meanwhile, in the following description, both the ink tanks will be simply referred to as an “ink tank 700” without distinction. Each ink tank 700 is coupled to the print head of the carriage by a tube (not illustrated). That is, the ink tank 700 is a stationary ink tank that is not mounted on the carriage of the printer 100. Further, each ink tank 700 is an ink replenishment-type ink tank to which ink is replenished from the ink replenishment container when the remaining amount of ink is low. Although the ink tank 700 is a stationary ink tank in the present embodiment, the ink tank 700 may be mounted on the carriage of the printer 100.

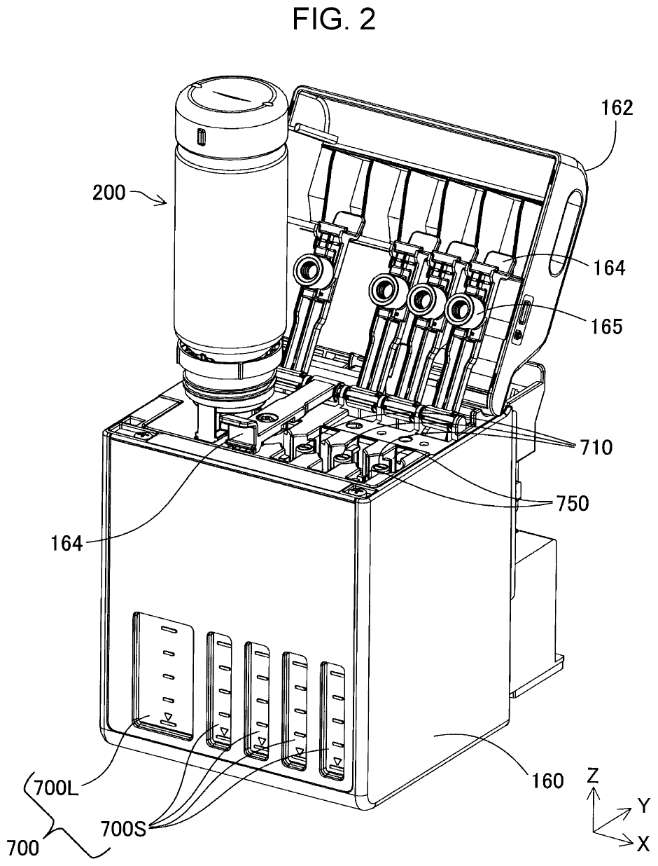

FIG. 2 is a perspective view illustrating a state where ink is replenished to the ink tank 700 by using an ink replenishment container 200. A front surface of each ink tank 700 is formed of a transparent member, and the remaining amount of ink in each ink tank 700 can be seen from the outside. When the remaining amount of ink is reduced, as illustrated in FIG. 2, the ink can be replenished from an ink introduction member 710 having a flow path communicating with the ink tank 700 by opening the lid 162. The ink introduction member 710 is a tubular member extending in the Z direction, which is a vertical direction, and is disposed as a component of the printer 100.

The tubular ink introduction member 710 for replenishing ink to the ink tank 700 is provided on an upper surface of each ink tank 700. The ink tank accommodation unit 160 includes a sealing cap member 164 having a sealing cap 165 for sealing a distal end of the ink introduction member 710. In a state where ink is not replenished to the ink tank 700, the distal end of the ink introduction member 710 is sealed by the sealing cap 165 of the sealing cap member 164. When the ink is replenished to the ink tank 700, the sealing cap member 164 is removed from the ink introduction member 710, and a distal end portion of the ink replenishment container 200 is inserted into a position of the ink introduction member 710 to replenish the ink. Two inlet formation portions 750 that are fitted with a protrusion portion of the ink replenishment container 200, which will be described later, are provided around the ink introduction member 710. The two inlet formation portions 750 have a shape that is rotationally symmetrical by 180 degrees with respect to the ink introduction member 710.

In the present specification, the term “ink replenishment” means an operation of supplying ink to the ink tank 700 to increase the remaining amount of ink. Meanwhile, the ink tank 700 does not need to be filled up with the ink through the “ink replenishment”. In addition, the “ink replenishment” also means an operation of filling the empty ink tank 700 with the ink when the printer 100 is used for the first time. As described above, the ink replenishment container 200 replenishes the ink to the ink tank 700 via the ink introduction member 710 having a flow path communicating with the ink tank 700.

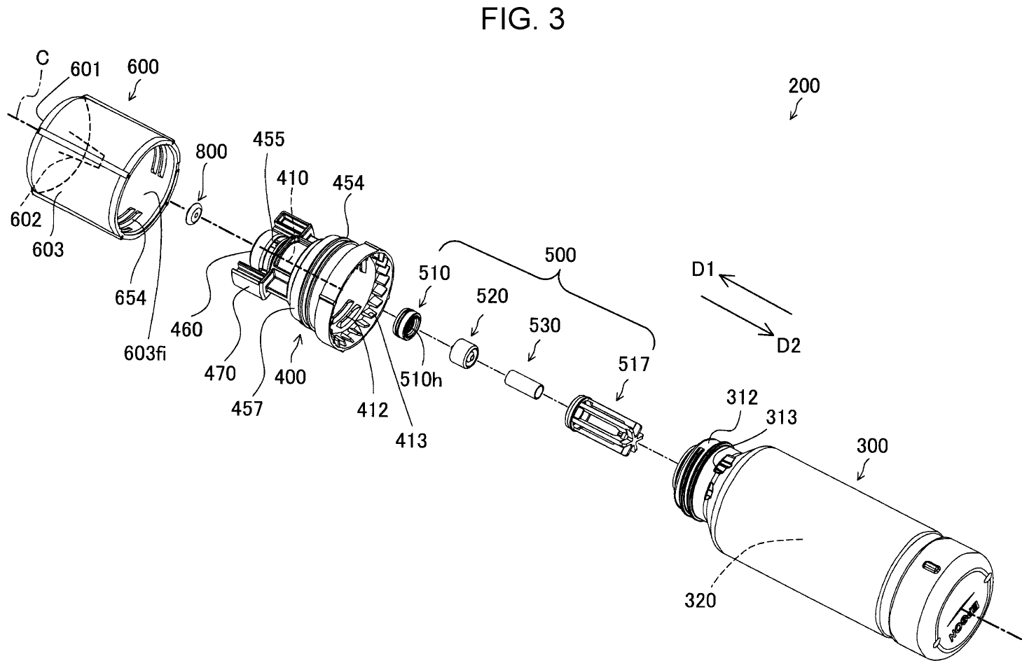

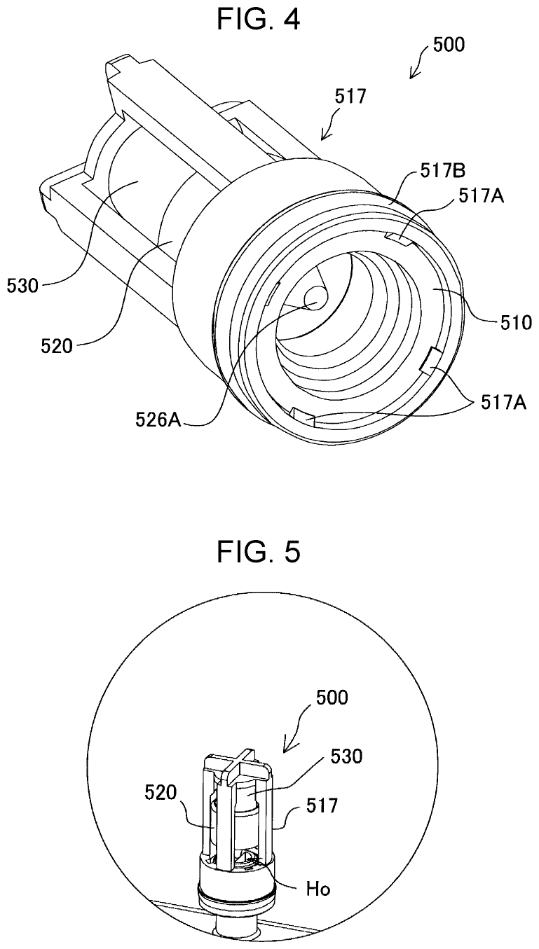

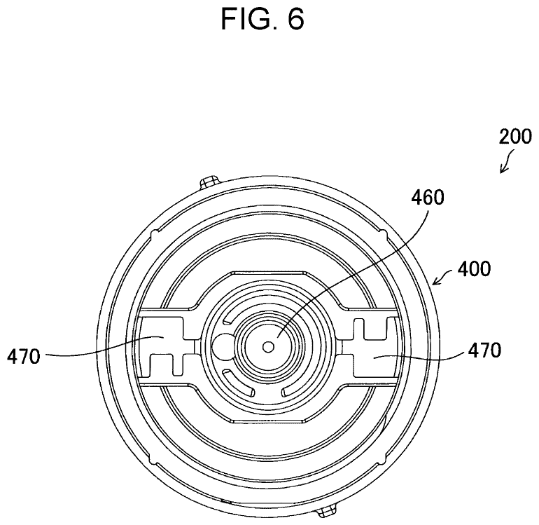

FIG. 3 is an exploded perspective view of the ink replenishment container 200 according to the embodiment. FIG. 4 is a first perspective view of a first valve 500. FIG. 5 is a second perspective view of the first valve 500. FIG. 6 is a view of the ink replenishment container 200 as seen from an outlet 460 side. The ink replenishment container 200 in FIG. 6 is in a state where the cap 600 is removed therefrom. As illustrated in FIG. 3, the ink replenishment container 200 includes a container main body portion 300, an ink outlet-forming portion 400, the first valve 500, a cap 600, and a second valve 800.

The container main body portion 300 is a bottomed tubular member. The container main body portion 300 has an ink accommodation chamber 320 that accommodates ink. The ink outlet-forming portion 400 is coupled to the container main body portion 300.

The ink outlet-forming portion 400 has a distal end portion 455. The distal end portion 455 is a tubular member. The distal end portion 455 has a central shaft C and an outlet 460 of the ink positioned on the opposite side of the container main body portion 300 and facing the outside. The distal end portion 455 defines an opening of the outlet 460 at a distal end thereof in a first direction D1, which will be described later. The outlet 460 is formed in a circular shape such that the ink introduction member 710 is inserted thereinto. As described above, the outlet 460 is formed at a distal end portion 455 of the ink outlet-forming portion 400. The distal end portion 455 is a tubular member. The ink outlet-forming portion 400 including the outlet 460 has the same central shaft C as the ink replenishment container 200. In addition, the ink outlet-forming portion 400 has an internal flow path 410 that provides fluid communication between the outlet 460 and the ink accommodation chamber 320. The internal flow path 410 is defined by disposing the first valve 500 in the ink outlet-forming portion 400.

The ink outlet-forming portion 400 includes protrusion portions 470 positioned on both sides of the distal end portion 455 including the outlet 460, and a proximal end portion 457 positioned on a side of a second direction D2, which will be described later, from the protrusion portion 470. The protrusion portion 470 protrudes radially outward from a side wall of the distal end portion 455, and further protrudes axially upward from the proximal end portion 457 side. The protrusion portion 470 has an identification shape that is fitted with the inlet formation portion 750 illustrated in FIG. 2. The identification shape of the protrusion portion 470 is a rib and groove shape formed on a side surface of the protrusion portion 470 and extending in an axial direction, and is formed to be rotationally symmetrical by 180 degrees with respect to the outlet 460. The inlet formation portion 750 is provided with a rib and a groove that are fitted or engaged with the identification shape of the protrusion portion 470. The identification shape of the protrusion portion 470 and a pattern shape of the rib and groove of the inlet formation portion 750 are different for each type of ink accommodated in the ink tank 700 and the ink replenishment container 200. As a result, when ink with different types, such as an ink color, is attempted to be replenished from the ink replenishment container 200 to the ink tank 700, the protrusion portion 470 and the inlet formation portion 750 interfere with each other, thereby preventing the ink introduction member 710 from being inserted into the outlet 460.

The proximal end portion 457 is a tubular member having an outer diameter larger than that of the distal end portion 455. A male screw portion 454 that is screwed into the cap 600 is formed on an outer peripheral surface, which is an outer surface of the proximal end portion 457. In addition, a female screw portion 412 that is screwed with an outer screw 312 of the container main body portion 300 is formed on an inner peripheral surface of the proximal end portion 457.

The ink outlet-forming portion 400 including the distal end portion 455 is formed of a synthetic resin such as polyethylene or polypropylene, and has rigidity as compared with a first valve body 520 of the first valve 500, which will be described later, or the second valve 800. That is, the ink outlet-forming portion 400 has rigidity that is higher than that of the first valve body 520 or the second valve 800.

An upper end side, which is a cap 600 side of the ink replenishment container 200, is also referred to as a “distal end side”, and a lower end side, which is a container main body portion 300 side, is also referred to as a “rear end side”. The container main body portion 300 is a hollow cylindrical container having an opening at the distal end side. The outer screw 312 for mounting the ink outlet-forming portion 400 is provided in a small-diameter part at a distal end of the container main body portion 300. In the present disclosure, a direction along the central shaft C of the ink replenishment container 200, that is, a direction parallel to the central shaft C is referred to as an “axial direction”, and a direction orthogonal to the axial direction is referred to as a “radial direction”. A direction from the ink accommodation chamber 320 toward the outlet 460 in the axial direction is also referred to as the first direction D1. Further, a direction opposite to the first direction D1 is referred to as the second direction D2.

The first valve 500 is disposed inside the ink outlet-forming portion 400. The first valve 500 controls a communication state of the internal flow path 410 through opening/closing. For example, the first valve 500 is in an open state by the ink introduction member 710 that is inserted from the outlet 460, and thus the internal flow path 410 is in the communication state. In addition, for example, the first valve 500 is in a closed state by the ink introduction member 710 that is removed from the outlet 460, and thus the internal flow path 410 is in a non-communication state.

The first valve 500 includes a sealing member 510, the first valve body 520, an elastic member 530, and a valve housing 517. The sealing member 510 is disposed in the distal end portion 455 having the outlet 460 of the ink outlet-forming portion 400. The sealing member 510 has an annular shape. A through-hole 510h is formed through the center of the sealing member 510 in the axial direction. The through-hole 510h forms a part of the internal flow path 410. The sealing member 510 is formed of, for example, a rubber member such as an elastomer having rubber elasticity. The elements of the ink replenishment container 200 other than the elastic member 530, the sealing member 510, the first valve body 520, and the second valve 800 can be formed of, for example, a synthetic resin such as polyethylene or polypropylene. As illustrated in FIG. 4, the sealing member 510 is supported by the valve housing 517 inside the valve housing 517. That is, the sealing member 510 is mounted in the valve housing 517.

As illustrated in FIG. 3, the first valve body 520 is positioned on the side of the second direction D2 from the sealing member 510. The first valve body 520 is movably disposed inside the valve housing 517 in the axial direction. The first valve body 520 faces the through-hole 510h in the axial direction. The first valve body 520 is biased by the elastic member 530 in the first direction D1, which is a direction toward the sealing member 510. That is, the elastic member 530 holds the state of the first valve 500 in a closed state where the first valve body 520 is in contact with the sealing member 510 such that the through-hole 510h of the sealing member 510 is closed. Specifically, the sealing member 510 has an annular protrusion at an end portion thereof in the second direction D2, and takes a state where the annular protrusion is in contact with an end surface, which extends in the radial direction at the end in the first direction D1 of the first valve body 520, is the closed state of the first valve 500. The elastic member 530 is a coil spring. The elastic member 530 is formed of, for example, metal. The elastic member 530 biases the first valve body 520 in the first direction D1 toward the sealing member 510.

As illustrated in FIG. 4, the ink introduction member 710 can be inserted into and removed from the valve housing 517. The valve housing 517 extends in the axial direction along the central shaft C. The valve housing 517 is mounted in the ink outlet-forming portion 400 such that a gap is provided in the radial direction between the valve housing 517 and the ink outlet-forming portion 400. The valve housing 517 accommodates the elastic member 530, the first valve body 520, and the sealing member 510 therein. The valve housing 517 includes retaining portions 517A at the distal end side thereof to suppress the sealing member 510 from coming out of the valve housing 517, and an engagement portion 517B that engages with the ink outlet-forming portion 400. Therefore, since the first valve 500 can be attached to and detached from the ink replenishment container 200 as a single element, thereby making the manufacture easy.

As illustrated in FIG. 5, the valve housing 517 has a total of four through-holes Ho formed therethrough in the radial direction. The through-holes Ho communicate with a gap in the radial direction between the valve housing 517 and the first valve body 520. The through-holes Ho are formed to extend in the axial direction. The through-holes Ho form a part of the internal flow path 410. In the open state of the first valve 500, a flow path formed inside the ink introduction member 710, which will be described later, communicates with the through-holes Ho, so that gas-liquid exchange is performed between the ink introduction member 710 and the ink replenishment container 200. As a result, the ink replenishment container 200 replenishes the ink to the ink tank 700.

As described above, the first valve 500 is a valve that performs opening/closing between the sealing member 510 and the first valve body 520 biased by the elastic member 530. Specifically, the first valve 500 is closed as being biased in the first direction D1 by the elastic member 530, and is opened by the ink introduction member 710 that is inserted from the outlet 460 in the second direction D2 against the biasing of the elastic member 530.

As illustrated in FIG. 3, the cap 600 has a top wall 601 facing the outlet 460 in the axial direction and a tubular side wall 603 having the central shaft C. The top wall 601 is positioned at an uppermost part of the cap 600 in an upright posture of the ink replenishment container 200. The side wall 603 is coupled to an outer circumferential portion of the top wall 601. The cap 600 is formed to be attachable to and detachable from the ink outlet-forming portion 400. The cap 600 further includes a center protrusion 602 that protrudes downward from a center portion of the top wall 601 when the top wall 601 is in a posture positioned on the side wall 603. Further, the cap 600 has a female screw portion 654 disposed on an inner peripheral surface 603fi of the side wall 603. The female screw portion 654 includes a plurality of stages of female screws. Details of the center protrusion 602 will be described later.

The second valve 800 is disposed in at least one of an inside of the ink outlet-forming portion 400 including the outlet 460 and an inside of the cap 600. In the present embodiment, the second valve 800 is disposed inside the cap 600. Specifically, the second valve 800 is attached to the center protrusion 602 of the cap 600. The second valve 800 is positioned between the ink accommodation chamber 320 and an outlet sealing portion of the cap 600, which will be described later. The second valve 800 is formed of, for example, a rubber member such as an elastomer having rubber elasticity. Details of the second valve 800 will be described later.

The ink replenishment container 200 further includes teeth 413 and claws 313 forming a ratchet mechanism. The teeth 413 are formed over a circumferential direction at an end portion of an inner peripheral surface of the proximal end portion 457, which is close to the second direction. The claws 313 are formed closer to the second direction D2 than a part of the outer peripheral surface of the container main body portion 300, in which the outer screw 312 is formed. After the female screw portion 412 of the ink outlet-forming portion 400 and the outer screw 312 of the container main body portion 300 are screwed, the teeth 413 of the ink outlet-forming portion 400 and the claws 313 of the container main body portion 300 are engaged and fixed. As a result, when the cap 600 is rotated in a direction of opening the cap 600, the ink outlet-forming portion 400 can be restricted from rotating together with the cap 600.

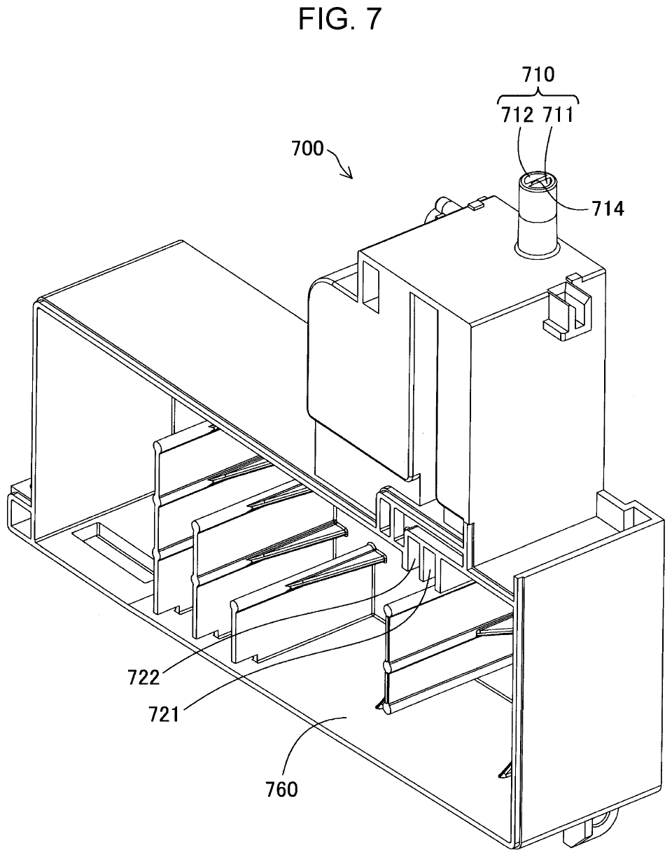

Before further describing the ink replenishment container 200 in detail, the configuration of the ink tank 700 will be described. FIG. 7 is a perspective view of the ink tank 700 of the embodiment. The ink introduction member 710 of the ink tank 700 protrudes upward from the ink tank 700.

The ink introduction member 710 has two flow paths 711 and 712. The two flow paths 711 and 712 are partitioned by a partition wall 714. When ink is replenished, one of the flow paths 711 and 712 forms a flow path of ink from the ink replenishment container 200, and the other thereof forms a flow path of air from the ink tank 700 to the ink replenishment container 200. The number of the flow paths 711 and 712 included in the ink introduction member 710 is not limited to two, and may be three or more as long as there are a plurality of flow paths.

The distal end of the ink introduction member 710 is flat, and each of the two flow paths 711 and 712 is opened at the distal end of the ink introduction member 710. In addition, a part of the distal end of the ink introduction member 710 corresponds to an end portion of the partition wall 714. The two flow paths 711 and 712 communicate with two in-tank flow paths 721 and 722 protruding downward into a tank-side ink accommodation chamber 760, respectively. Lower ends of the in-tank flow paths 721 and 722 extend to a position below a ceiling wall of the tank-side ink accommodation chamber 760. The reason is that when the ink is replenished from the ink replenishment container 200 to the ink tank 700, the gas-liquid exchange is stopped when a liquid level in the tank-side ink accommodation chamber 760 reaches the lower ends of the in-tank flow paths 721 and 722, and the ink replenishment is accordingly stopped, so that the replenishment work of the ink is easy.

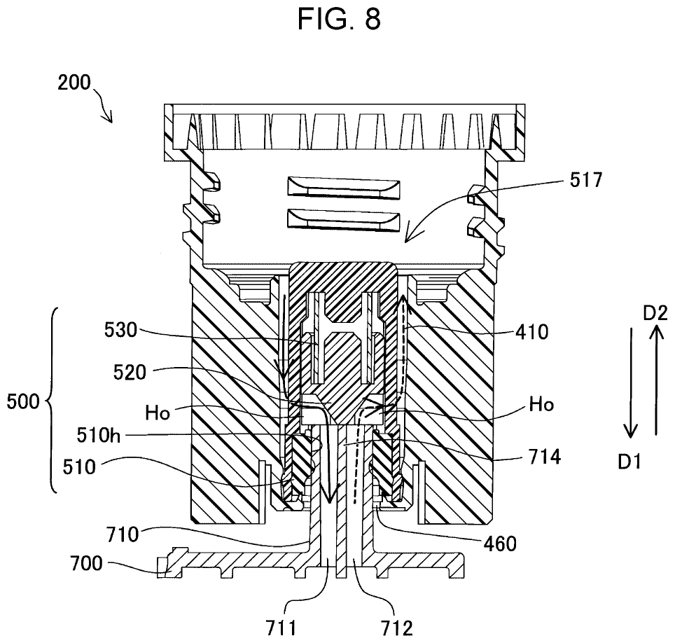

FIG. 8 is a view illustrating a state where the ink is replenished from the ink replenishment container 200 to the ink tank 700. The ink replenishment posture of the ink replenishment container 200 is an inverted posture in which an opening direction of the outlet 460 is the vertically downward direction. The ink introduction member 710 of the ink tank 700 is inserted into the internal flow path 410, which is a flow path of a fluid inside the ink outlet-forming portion 400, via the through-hole 510h of the sealing member 510. As a result, the first valve body 520 is displaced in the second direction D2, which is a direction away from the sealing member 510, by the ink introduction member 710, and thus the first valve body 520 is separated from the sealing member 510. Therefore, the first valve 500 is in the open state. The ink in the ink accommodation chamber 320 of the container main body portion 300 is supplied to the ink introduction member 710 via the internal flow path 410 formed by the gap between the inner peripheral surface of the ink outlet-forming portion 400 and the valve housing 517, the through-hole Ho, or the like, and the air from the tank-side ink accommodation chamber 760 flows into the ink accommodation chamber 320 via the internal flow path 410. As a result, the gas-liquid exchange is performed, and the ink is replenished to the ink tank 700. In FIG. 8, the arrow indicated by the solid line schematically indicates the flow of ink, and the arrow indicated by the dashed line schematically indicates the flow of air.

When the replenishment of the ink to the ink tank 700 is completed and the ink replenishment container 200 is removed from the ink introduction member 710, the first valve body 520 comes into contact with the sealing member 510 by a biasing force of the elastic member 530. As a result, the through-hole 510h of the sealing member 510 is closed by the valve body 520, and thus the internal flow path 410 is blocked and the first valve 500 is in the closed state. The first valve 500 is in the closed state, so that it is possible to suppress the ink in the ink replenishment container 200 from leaking to the outside. When the ink is replenished from the ink replenishment container 200 to the ink tank 700, it is not necessary to squeeze the container main body portion 300. As described above, a type of ink replenishment container capable of replenishing the ink without squeezing the container main body portion 300 is also referred to as a “non-squeeze type”.

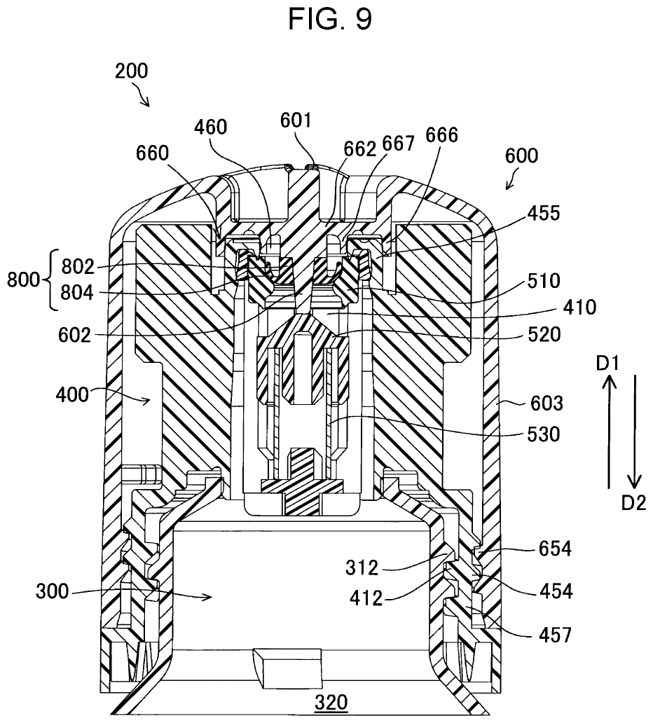

FIG. 9 is a view for further explaining the ink replenishment container 200. FIG. 9 is a longitudinal cross-sectional view of a side of the ink replenishment container 200 including the cap 600. FIG. 9 is a view of the cap 600 in the mounted state where the screwing between the female screw portion 654 of the cap 600 and the male screw portion 454 of the ink outlet-forming portion 400 is completed and the mounting of the cap 600 on the ink outlet-forming portion 400 is completed.

The cap 600 further has an outlet sealing portion 660 that seals the outlet 460 by being engaged with the ink outlet-forming portion 400. The outlet sealing portion 660 faces the outlet 460. The outlet sealing portion 660 includes a disc-shaped bottom wall 662 positioned close to the second direction D2, and two peripheral walls 666 and 667 that stand up from the bottom wall 662 toward the second direction D2. The first peripheral wall 666 stands up from an outer peripheral edge of the bottom wall 662 toward the second direction D2, and is formed over the circumferential direction. The second peripheral wall 667 stands up from a part of the bottom wall 662, which is provided radially inward of the first peripheral wall 666, toward the second direction D2, and is formed over the circumferential direction. It can be said that the center protrusion 602 passes through the part of the bottom wall 662, which is provided radially inward of the second peripheral wall 667, and protrudes toward the second direction D2. The outlet sealing portion 660 and the ink outlet-forming portion 400 are engaged with each other by accommodating the distal end portion 455 in a recessed portion 664 defined by the bottom wall 662, the first peripheral wall 666, and the second peripheral wall 667. As a result, in the present embodiment, the outer peripheral surface of the distal end portion 455 comes into contact with the first peripheral wall 666, so that the outlet 460 is sealed by the outlet sealing portion 660 of the cap 600. That is, in the mounted state of the cap 600, the outlet 460 is in the sealed state. The sealing method of the outlet 460 of the outlet sealing portion 660 is not limited to the present embodiment, and the outlet 460 may be sealed by the outlet sealing portion 660. For example, in another embodiment, the second peripheral wall 667 may seal the outlet 460 by coming into contact with the inner peripheral surface of the distal end portion 455, or the outlet sealing portion 660 may seal the outlet 460 by coming into contact with the distal end surface of the distal end portion 455 that defines the outlet 460.

The second valve 800 has a valve shaft portion 802 and a second valve body 804. The second valve 800 is formed of a rubber member such as an elastomer having rubber elasticity. In a state where the cap 600 is mounted on the ink outlet-forming portion 400, the second valve 800 is positioned between the first valve body 520 and the outlet 460 in the internal flow path 410. The second valve 800 controls the communication state of the internal flow path 410. The second valve 800 is a differential pressure valve that is opened when a pressure difference ΔP between regions with the second valve 800 interposed therebetween is equal to or greater than a predetermined value P1. Specifically, the second valve 800 is opened when a pressure difference ΔP between a first pressure in a space on the ink accommodation chamber 320 of the second valve 800 side and a second pressure in a space on the outlet sealing portion 660 side of the second valve 800 is equal to or greater than the predetermined value P1. Specifically, when the first pressure is higher than the second pressure by the predetermined value P1 or greater, the second valve 800 is opened. The predetermined value P1 is, for example, in a range of 3 kPa or greater and 8 kPa or less, and is 5 kPa in the present embodiment.

The valve shaft portion 802 is a tubular member, and the center protrusion 602 is inserted thereinto. That is, the second valve 800 including the second valve body 804 is disposed on the center protrusion 602 of the cap 600 and is disposed in the cap 600. The second valve body 804 is a film-shaped member extending from the end portion of the valve shaft portion 802 close to the second direction D2 toward a radially outer side. The second valve body 804 is formed over the circumferential direction. In the sealed state of the cap 600 in which the outlet 460 is sealed, when the pressure difference ΔP between the first pressure and the second pressure is less than the predetermined value P1, the second valve body 804 comes into contact with the other member, which is at least one of the sealing member 510 and the distal end portion 455, thereby entering the closed state. In the state illustrated in FIG. 9, the second valve body 804 comes into contact with the inner peripheral surface of the sealing member 510 to close to the through-hole 510h, so that the second valve 800 is in the closed state. The second valve body 804 has elasticity enough to open the second valve body 804 by elastic deformation when the pressure difference ΔP between the first pressure and the second pressure is equal to or greater than the predetermined value P1. Details of the opening/closing of the second valve 800 will be described later.

In the sealed state of the outlet 460, the center protrusion 602 is pressed toward the second direction D2, which is a direction in which the first valve body 520 is separated from the sealing member 510, against the biasing of the elastic member 530. As a result, in the mounted state of the cap 600 and the sealed state of the outlet 460, the first valve body 520 and the sealing member 510 are separated from each other so that the first valve 500 is in the open state.

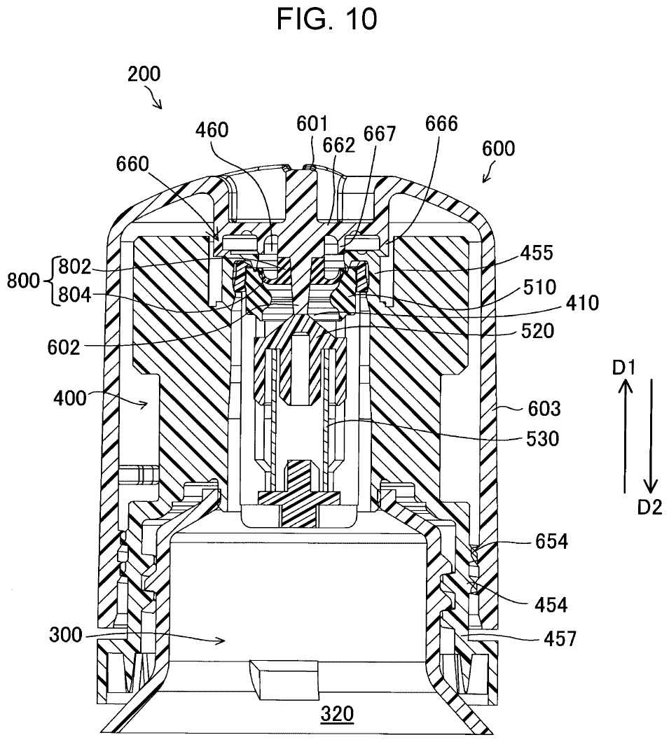

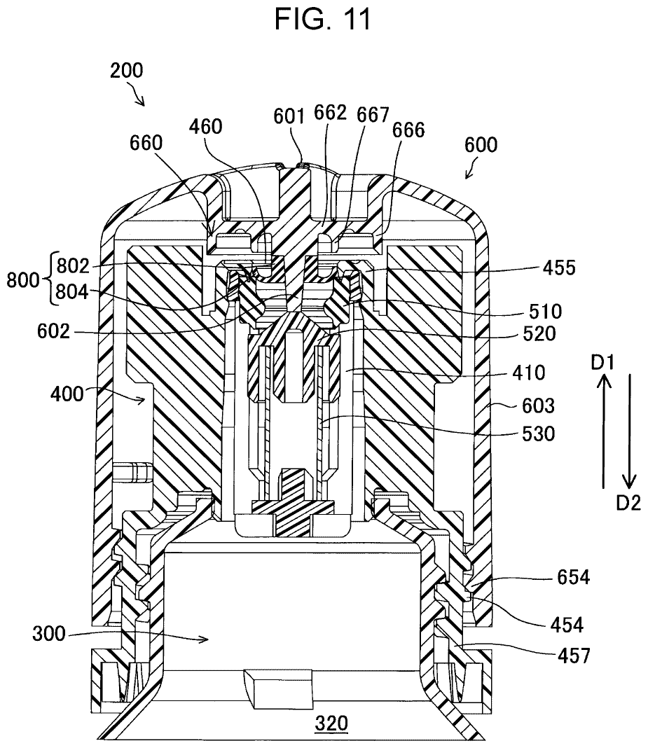

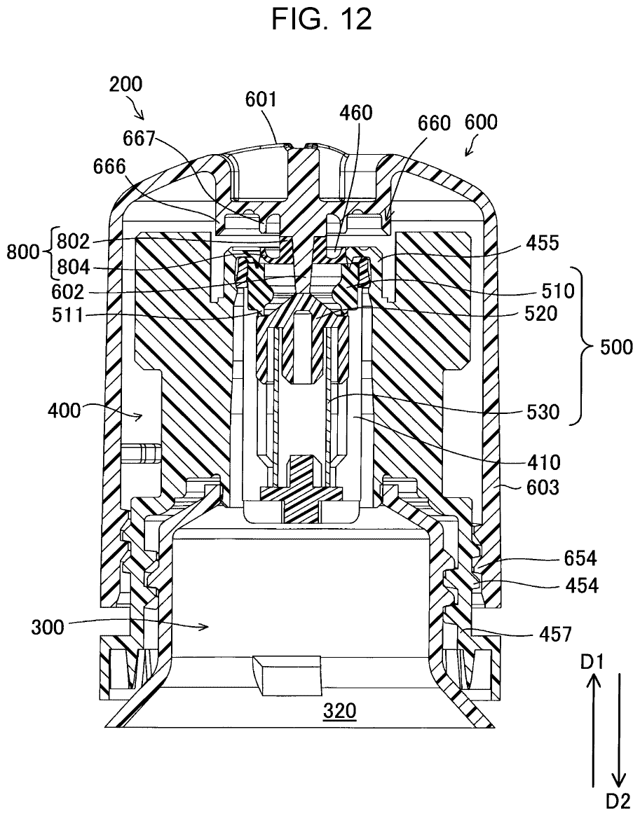

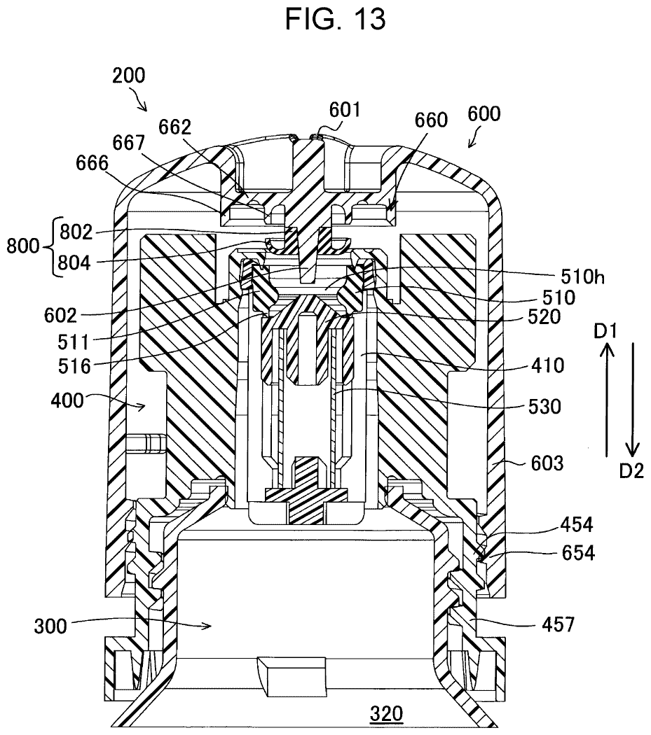

FIG. 10 is a partial cross-sectional view illustrating the ink replenishment container 200 at a first timing of a release process of releasing the sealed state of the outlet 460. FIG. 11 is a partial cross-sectional view illustrating the ink replenishment container 200 at a second timing in the release process. FIG. 12 is a first partial cross-sectional view in a released state where release of the sealed state is completed. FIG. 13 is a second partial cross-sectional view in the released state where release of the sealed state is completed. In the release process, the second timing is a timing after the release is progressed from the first timing. That is, the state of the ink replenishment container 200 transitions from the state illustrated in FIG. 9 to the state illustrated in FIG. 13 by the user who performs an operation of relatively rotating the cap 600 with respect to the ink outlet-forming portion 400 in the axial direction and releasing the screwing between the female screw portion 654 of the cap 600 and the male screw portion 454 of the ink outlet-forming portion 400. As the state transitions from the state illustrated in FIG. 9 to the state illustrated in FIG. 13, the cap 600 is displaced toward the second direction D2, which is a direction away from the ink outlet-forming portion 400, and the user's opening operation of cap 600 is progressed.

The first timing illustrated in FIG. 10 corresponds to a state immediately before the sealing of the outlet 460 by the outlet sealing portion 660 is released. In addition, the first timing is immediately before the gap is formed between the female screw portion 654 of the cap 600 and the male screw portion 454 of the ink outlet-forming portion 400. That is, at the first timing, the inside of the outlet sealing portion 660 of the cap 600 is not opened to the atmosphere. In the state illustrated in FIG. 10, when the pressure difference ΔP between the first pressure and the second pressure is less than the predetermined value P1, the second valve body 804 comes into contact with the inner peripheral surface of the sealing member 510, and the second valve 800 is in the closed state. Since the second valve 800 is in the closed state, the internal flow path 410 is in the non-communication state. In addition, in the state illustrated in FIG. 10, the first valve body 520 is pressed by the center protrusion 602 toward the second direction D2 to be separated from the sealing member 510. That is, the first valve 500 is in the open state.

The second timing illustrated in FIG. 11 corresponds to a state where the sealing of the outlet 460 by the outlet sealing portion 660 is released. In addition, the second timing corresponds to a state where the gap is formed between the female screw portion 654 of the cap 600 and the male screw portion 454 of the ink outlet-forming portion 400. That is, the inside of the cap 600 is opened to the atmosphere via the gap between the female screw portion 654 and the male screw portion 454. In the state illustrated in FIG. 11, when the pressure difference ΔP is less than the predetermined value P1, the second valve body 804 comes into contact with the inner peripheral surface of the sealing member 510 and the inner peripheral surface of the distal end portion 455, and the second valve 800 is in the closed state. Since the second valve 800 is in the closed state, the internal flow path 410 is in the non-communication state. In addition, in the state illustrated in FIG. 11, the first valve body 520 is pressed toward the second direction D2 by the center protrusion 602 to be separated from the sealing member 510. That is, the first valve 500 is in the open state. In the second timing, the first valve 500 is in the open state, and the sealed state of the outlet 460 by the cap 600 is released, but the second valve 800 is in the closed state. As a result, in a process of the opening operation of removing the cap 600 from the ink replenishment container 200, even when the outlet 460 is turned sideways or the outlet 460 is turned in a direction having a vertical downward component, it is possible to suppress the ink in the ink accommodation chamber 320 from flowing out from the outlet 460.

In the state illustrated in FIG. 12, the outlet sealing portion 660 is separated from the distal end portion 455, and thus the sealing of the outlet 460 by the outlet sealing portion 660 is released. In addition, in the state illustrated in FIG. 12, as in the second timing illustrated in FIG. 11, the gap is formed between the female screw portion 654 of the cap 600 and the male screw portion 454 of the ink outlet-forming portion 400, and the inside of the cap 600 is opened to the atmosphere. In addition, in the state illustrated in FIG. 12, the first valve body 520 is slightly separated from the sealing member 510, and the first valve 500 is in the open state. On the other hand, in the state illustrated in FIG. 12, when the pressure difference ΔP is less than the predetermined value P1, the second valve body 804 comes into contact with the inner peripheral surface of the distal end portion 455, and the second valve 800 is in the closed state. As a result, in a process of the opening operation of removing the cap 600 from the ink replenishment container 200, even when the outlet 460 is turned sideways or the outlet 460 is turned in a direction having a vertical downward component, it is possible to suppress the ink in the ink accommodation chamber 320 from flowing out from the outlet 460.

In the state illustrated in FIG. 13, the opening operation of the cap 600 is further progressed as compared with the state illustrated in FIG. 12. In the state illustrated in FIG. 13, the sealing of the outlet 460 by the outlet sealing portion 660 is released. In addition, in the state illustrated in FIG. 13, the gap is formed between the female screw portion 654 of the cap 600 and the male screw portion 454 of the ink outlet-forming portion 400, and the inside of the cap 600 is opened to the atmosphere. In addition, in the state illustrated in FIG. 13, the first valve body 520 comes into contact with the sealing member 510, and the first valve body 520 closes the through-hole 510h.

The sealing member 510 has a sealing portion main body 511 having a tubular shape and press-fitted to the distal end portion 455 and a first sealing portion 516 which is an end portion close to the second direction D2. The first sealing portion 516 is an annular protrusion, and faces a valve body distal end portion 526 of the first valve body 520 close to the first direction D1. The first sealing portion 516 protrudes from the sealing portion main body 511 toward the second direction D2. The valve body distal end portion 526 comes into contact with the first sealing portion 516 so that the through-hole 510h of the first valve body 520 is closed. That is, a part at which the valve body distal end portion 526 of the first valve body 520 comes into contact with or is separated from the first sealing portion 516 functions as a first opening/closing portion that performs opening/closing of the first valve 500. In other words, the first opening/closing portion is a part in which the valve body distal end portion 526 and the first sealing portion 516 face each other in the axial direction. In the state illustrated in FIG. 13, the first valve 500 is in the closed state, and the internal flow path 410 is in the non-communication state. In addition, the second valve body 804 is separated from a member that defines the internal flow path 410, for example, the inner peripheral surface of the sealing member 510 or the distal end portion 455. Therefore, the second valve 800 is in the open state. In the state illustrated in FIG. 13, the second valve 800 is in the open state, but the first valve 500 is in the closed state, and thus even when the outlet 460 is turned sideways or the outlet 460 is turned in a direction having a vertical downward component, it is possible to suppress the ink in the ink accommodation chamber 320 from flowing out from the outlet 460. Even when the opening operation of the cap 600 is progressed further than the state illustrated in FIG. 13 and the cap 600 is displaced toward the second direction D2 with respect to the ink outlet-forming portion 400, the first valve 500 maintains the closed state.

As described above, at least in a release process period from the sealed state of the cap 600 to a state where the sealed state is released, when the pressure difference ΔP is less than the predetermined value P1, the second valve 800 maintains the closed state. In the release process period from the sealed state of the cap 600 to the state where the sealed state is released, the first valve 500 maintains the open state by the center protrusion 602. In particular, in the present embodiment, in a predetermined period, which is a period in which the first valve 500 maintains the open state by the center protrusion 602, when the pressure difference ΔP is less than the predetermined value P1, the second valve 800 maintains the closed state. The release process period is a part of the predetermined period. In addition, as illustrated in FIG. 13, in the released state where the sealed state is released and in the closed state of the first valve 500, the second valve 800 is separated from the sealing member 510 and the distal end portion 455, which are other members.

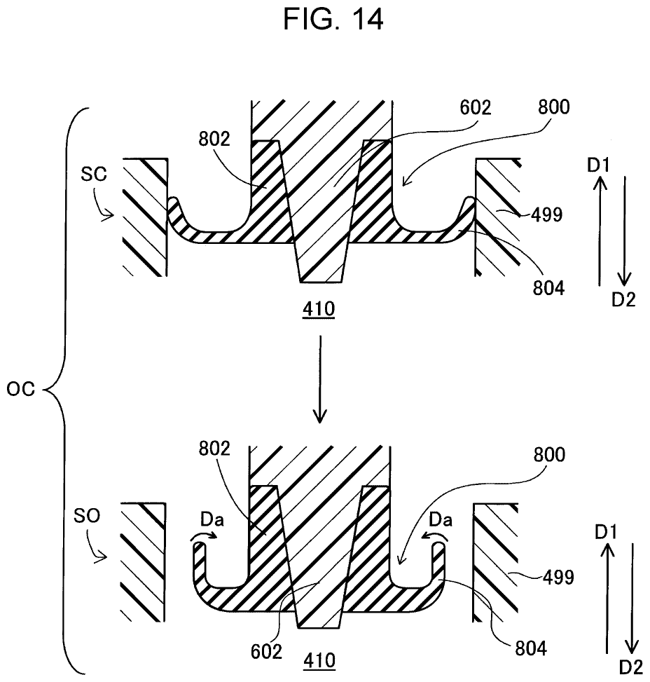

FIG. 14 is a view for explaining an opening/closing operation OC of the second valve 800. FIG. 14 schematically illustrates a closed state SC and an open state SO of the second valve 800. As described above, in the closed state SC of the second valve 800, the second valve body 804 comes into contact with the other member 499 that defines the internal flow path 410. As described above, another member 499 includes the sealing member 510 and the distal end portion 455 illustrated in FIG. 9. When the second valve 800 is in the closed state SC, the internal flow path 410 is in the non-communication state even if the first valve 500 is in the open state, as illustrated in FIGS. 9 to 12. The closed state SC of the second valve 800 is maintained when the pressure difference ΔP is less than the predetermined value P1.

On the other hand, due to pressure change or temperature change in an environment in which the ink replenishment container 200 is disposed, a case where the pressure difference ΔP is equal to or greater than the predetermined value P1, in detail, a case where the first pressure close to the ink accommodation chamber 320 is higher than the second pressure close to the outlet sealing portion 660 by the predetermined value P1 or greater may occur in the ink replenishment container 200. In this case, the second valve body 804 is deformed in a radially inward direction Da to be separated from the other member 499 by using the pressure difference ΔP as a driving force. As a result, the second valve 800 is in the open state SO by the second valve body 804 that is separated from the other member 499. When the second valve 800 is in the open state SO, the internal flow path 410 is in the communication state, and the air close to the ink accommodation chamber 320 flows out into the cap 600 via the outlet 460. In the process of the opening operation of the cap 600, the air that flows out into the cap 600 is opened to the atmosphere via the gap formed between the female screw portion 654 and the male screw portion 454, and flows out of the cap 600. As a result, it is possible to suppress an increase in the pressure inside the ink accommodation chamber 320.

According to the first embodiment, as illustrated in FIG. 9, the second valve 800, which is a differential pressure valve, is disposed between the ink accommodation chamber 320 and the outlet sealing portion 660, and when the pressure difference ΔP is less than the predetermined value P1, the second valve 800 maintains the closed state. As a result, even when the sealed state of the cap 600 is released in any posture of the ink replenishment container 200, it is possible to suppress the ink from leaking to a downstream, that is, an outer side of the second valve 800. Therefore, it is possible to suppress the occurrence of ink stain. In addition, when the ink replenishment is completed and the ink replenishment container 200 after use is collected, even if the cap 600 is in a state of incompletely sealing the outlet 460, it is difficult for the ink to leak downstream of the second valve 800. As a result, it is possible to suppress the occurrence of ink stain even when the ink replenishment container 200 is collected. In addition, for example, when the sealing of the cap 600 is released in a posture in which the outlet 460 is directed upward, the second valve 800 is opened when the pressure difference ΔP is equal to or greater than the predetermined value P1. As a result, even when the pressure in the ink accommodation chamber 320 increases due to temperature change or pressure change, the air in the ink accommodation chamber 320 can flow out of the ink replenishment container 200 via the second valve 800. Therefore, a pressurized state of the ink accommodation chamber 320 can be easily eliminated. When the pressurized state of the ink accommodation chamber 320 is eliminated and the pressure difference ΔP is less than the predetermined value P1, the second valve 800 maintains the closed state again.

Further, according to the first embodiment, even if the first valve 500 is in the open state, the second valve 800 is in the closed state when the pressure difference ΔP is less than the predetermined value P1, so that it is possible to suppress the ink from flowing out of the downstream of the second valve 800.

Further, according to the first embodiment, as illustrated in FIGS. 9 to 12, in the release process period, when the pressure difference ΔP is less than the predetermined value P1, the release process is progressed while maintaining the closed state of the second valve 800, so that the second valve 800 is displaced in the first direction D1. As a result, the volume of the closed space from the ink accommodation chamber 320 to the second valve 800 is expanded. As the volume of the closed space is expanded, a pressure of the closed space is reduced, so that the ink is easily sucked to the inner side of the ink outlet-forming portion 400 when the sealed state of the cap 600 is released. Thus, it is possible to further suppress the ink from leaking to the outside. In addition, as illustrated in FIG. 13, in a state where the sealed state of the cap 600 is released and in the closed state of the first valve 500, the second valve 800 is in the open state while being separated from the sealing member 510 or the distal end portion 455. However, since the first valve 500 is in the closed state, it is possible to suppress the ink from leaking to the downstream of the first valve 500. In addition, since the second valve 800 including the second valve body 804 is disposed in the cap 600, the second valve 800 can be replaced together with the cap 600, such as when the second valve 800 is deteriorated.

### B. Second Embodiment

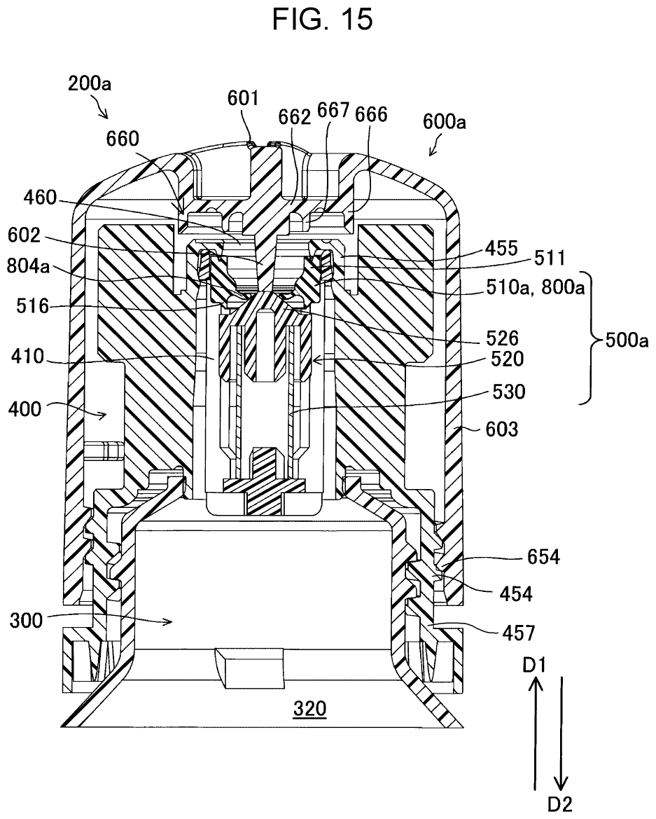

FIG. 15 is a view for explaining an ink replenishment container 200a of a second embodiment. FIG. 15 is a partial cross-sectional view of the ink replenishment container 200a, and shows a state at a predetermined timing in an opening operation process of a cap 600a. In addition, in the state illustrated in FIG. 15, a gap is formed between a female screw portion 654 and a male screw portion 454, and an inside of the cap 600a communicates with atmosphere via the gap. In addition, in the state illustrated in FIG. 15, an outlet sealing portion 660 is separated from a distal end portion 455, and is in a released state where the sealing of an outlet 460 is released. A difference between the ink replenishment container 200a and the ink replenishment container 200 of the first embodiment illustrated in FIG. 9 is the configurations of a sealing member 510a of a first valve 500a and a second valve 800a. Other configurations of the ink replenishment container 200a of the second embodiment are the same as those of the ink replenishment container 200 of the first embodiment, and the same configurations will be denoted by the same reference numerals, and the description thereof will be appropriately omitted.

The second valve 800a is a differential pressure valve integrally formed with the sealing member 510a of the first valve 500a. The second valve 800a is positioned between an ink accommodation chamber 320 and the outlet sealing portion 660. The second valve 800a has a second valve body 804a integrally formed with the sealing member 510a. The second valve body 804a is a film-shaped member extending radially inward from an inner peripheral surface of a sealing portion main body 511, and is integrally formed with the sealing member 510a. The second valve body 804a is formed over a circumferential direction of the inner peripheral surface of the sealing portion main body 511. The second valve body 804a is positioned closer to a first direction D1 than a first sealing portion 516. The sealing member 510a and the second valve 800a are formed of a rubber member such as an elastomer having rubber elasticity, as in the first embodiment.

The second valve body 804a has a part of a through-hole 510h formed at the center thereof. The second valve 800a controls a communication state of an internal flow path 410 by the second valve body 804a that comes into contact with or is separated from a valve body distal end portion 526 of a first valve body 520. Specifically, when a pressure difference ΔP between a first pressure in a space on the ink accommodation chamber 320 side of the second valve 800a and a second pressure in a space on the outlet sealing portion 660 side of the second valve 800a is less than a predetermined value P1, the second valve body 804a comes into contact with the valve body distal end portion 526, thereby entering the closed state. In addition, the second valve body 804a has elasticity enough to open the second valve body 804a by elastic deformation when the pressure difference ΔP is equal to or greater than the predetermined value P1. Specifically, when the first pressure is higher than the second pressure by the predetermined value P1 or greater, the second valve body 804a is deformed to be separated from the valve body distal end portion 526 so that the second valve body 804a is separated from the first valve body 520. As a result, the second valve 800a is opened. The predetermined value P1 is, for example, in a range of 3 kPa or greater and 8 kPa or less, and is 5 kPa in the present embodiment as in the first embodiment.

As in the first embodiment, in a release process period of the cap 600a from the sealed state where the outlet 460 is sealed to a state where the sealed state is released, when the pressure difference ΔP is less than the predetermined value P1, the second valve 800a maintains the closed state, and the second valve body 804a comes into contact with the valve body distal end portion 526. On the other hand, in the release process period, the first valve body 520 is in the open state because the first valve body 520 is pressed by a center protrusion 602 toward a second direction D2 to be separated from the sealing member 510a. In the second embodiment, as in the first embodiment, when the pressure difference ΔP is less than a predetermined value in a predetermined period, which is a period in which the first valve 500a maintains the open state by the center protrusion 602, the second valve 800a maintains the closed state. The release process period is a part of the predetermined period. In the second embodiment, even after an opening operation of the cap 600a is progressed so that the first valve body 520 comes into contact with a first sealing portion 516 and the first valve 500a is switched from the open state to the closed state, the second valve body 804a comes into contact with the inner peripheral surface of the sealing portion main body 511, and the second valve 800a maintains the closed state.

As described above, a part at which the first valve body 520 comes into contact with or is separated from the first sealing portion 516 functions as a first opening/closing portion that performs opening/closing of the first valve 500a. In addition, the first opening/closing portion, specifically, a part, which is positioned closer to the first direction D1 than the first sealing portion 516 and at which the first valve body 520 comes into contact with or is separated from the second valve body 804a, functions as a second opening/closing portion that performs opening/closing of the second valve 800a.

According to the second embodiment, the same effects are achieved in terms of having the same configuration as the first embodiment. In addition, according to the second embodiment, since the second valve 800a can suppress the ink from flowing out of a space in an ink outlet-forming portion 400 that is provided on a downstream of the part in which the second valve body 804a comes into contact with the first valve body 520, even when the cap 600a is opened in a state where the outlet 460 is directed downward or the like, it is possible to suppress the ink from dripping from the outlet 460. Therefore, it is possible to suppress the occurrence of ink stain. In addition, the second valve body 804a comes into contact only with the first valve body 520 having rigidity. As a result, since the second valve body 804a can be brought into contact with or separated from the first valve body 520, which is easier to manage a dimension than the member having elasticity, the opening/closing operation of the second valve body 804a can be made more stable.

### C. Third Embodiment

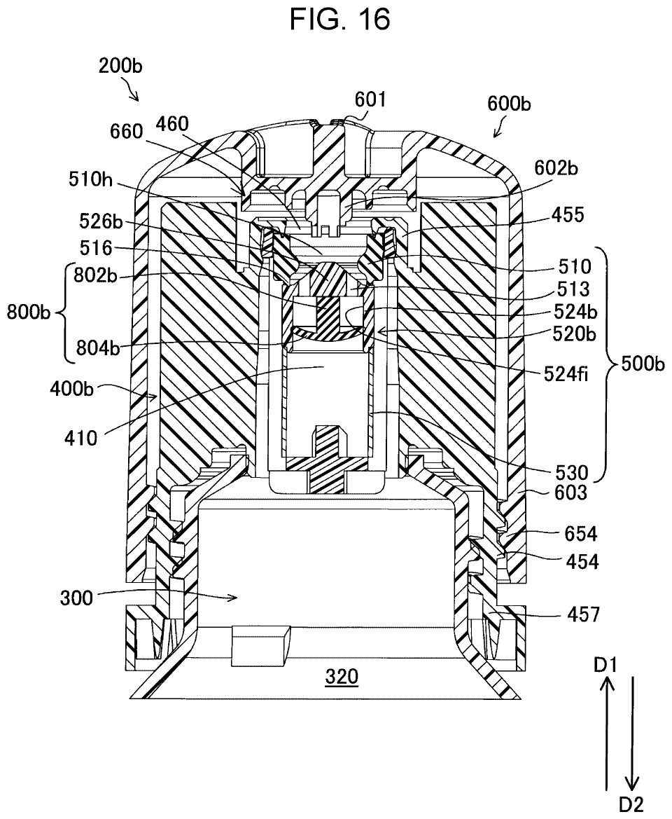

FIG. 16 is a view for explaining an ink replenishment container 200b of a third embodiment. FIG. 16 is a partial cross-sectional view of the ink replenishment container 200b, and shows a state at a predetermined timing in an opening operation process of a cap 600b. In addition, in the state illustrated in FIG. 16, a gap is formed between a female screw portion 654 and a male screw portion 454, and an inside of the cap 600b communicates with atmosphere via the gap. In addition, in the state illustrated in FIG. 16, an outlet sealing portion 660 is separated from a distal end portion 455, and is in a released state where the sealing of an outlet 460 is released. A difference between the ink replenishment container 200b and the ink replenishment container 200 of the first embodiment illustrated in FIG. 9 is the configuration of a first valve body 520b of a first valve 500b, the configuration of a second valve 800b, and the configuration of a center protrusion 602b of the cap 600b. Other configurations of the ink replenishment container 200b of the third embodiment are the same as those of the ink replenishment container 200 of the first embodiment, and the same configurations will be denoted by the same reference numerals, and the description thereof will be appropriately omitted.

The first valve 500b has a sealing member 510, the first valve body 520b, and an elastic member 530. The sealing member 510 is disposed in a tubular distal end portion 455 having an outlet 460. The first valve body 520b has a valve body distal end portion 526b and a valve body proximal end portion 524b. The valve body distal end portion 526b faces the first sealing portion 516 in the axial direction. The valve body distal end portion 526b has a substantially frustum shape. The valve body distal end portion 526b has a part that comes into contact with the first sealing portion 516 over a circumferential direction. The first valve body 520b including the valve body distal end portion 526b is disposed in an ink outlet-forming portion 400 o be displaceable in the axial direction. As a result, the valve body distal end portion 526b can come into contact with or be separated from the first sealing portion 516. The valve body distal end portion 526b has a communication hole 513 formed radially inward of the part that comes into contact with the first sealing portion 516. The communication hole 513 is a hole formed through the valve body distal end portion 526b in an axial direction, and forms a part of an internal flow path 410. In the present embodiment, two communication holes 513 are formed.

The valve body proximal end portion 524b is a tubular member extending from an end surface of the valve body distal end portion 526b close to the second direction D2 toward the second direction D2. An inside of the valve body proximal end portion 524b communicates with the communication hole 513 and an ink accommodation chamber 320, and forms a part of the internal flow path 410.

The elastic member 530 biases the first valve body 520b toward the first sealing portion 516 in a first direction D1, and brings the first valve body 520b into contact with the first sealing portion 516.

The center protrusion 602b of the cap 600b is shorter than the center protrusion 602 of the first embodiment illustrated in FIG. 9. The center protrusion 602b is separated from the first valve body 520b even in the sealed state where the cap 600b is mounted on an ink outlet-forming portion 400b and the outlet 460 is sealed by the outlet sealing portion 660. That is, in a period of an opening operation of the cap 600b, which includes a release process period from the sealed state of the cap 600b to a state where the sealed state is released, the first valve body 520b maintains the contact with the first sealing portion 516.

The second valve 800b has a valve shaft portion 802b and a second valve body 804b. The second valve 800b is disposed closer to the second direction D2 than the first sealing portion 516. Specifically, the second valve 800b is disposed in the valve body proximal end portion 524b. The valve shaft portion 802b has a cylindrical shape. An end portion of the valve shaft portion 802b close to the first direction D1 is attached to the valve body distal end portion 526b. The second valve body 804b is a film-shaped member extending radially outward from the end portion of the valve shaft portion 802b toward the second direction D2. The second valve body 804b is a circular member when viewed in the axial direction. The sealing member 510 and the second valve 800b are formed of a rubber member such as an elastomer having rubber elasticity, as in the first embodiment.

The second valve body 804b controls a communication state of the internal flow path 410 by coming into contact with or being separated from an inner wall 524fi of the valve body proximal end portion 524b that defines the internal flow path 410. Specifically, when a pressure difference ΔP between a first pressure in a space on the ink accommodation chamber 320 side of the second valve body 804b and a second pressure in a space on the outlet sealing portion 660 side of the second valve body 804b is less than a predetermined value P1, the second valve body 804b comes into contact with the inner wall 524fi of the valve body proximal end portion 524b over the circumferential direction to come into contact with the valve body distal end portion 526, thereby entering the closed state. In addition, the second valve body 804b has elasticity enough to open the second valve body 804b by elastic deformation when the pressure difference ΔP is equal to or greater than the predetermined value P1. Specifically, when the first pressure is higher than the second pressure by the predetermined value P1 or greater, the second valve body 804b is deformed to be separated from an inner peripheral surface of the valve body proximal end portion 524b. In the deformation, a side of the second valve body 804b that comes into contact with the inner wall 524fi of the valve body proximal end portion 524b bends toward the first direction D1 by using the pressure difference as a driving force. As a result, the second valve 800b is opened, and the internal flow path 410 is in a communication state regardless of whether or not the first valve body 520b comes into contact with the first sealing portion 516. The predetermined value P1 is, for example, in a range of 3 kPa or greater and 8 kPa or less, and is 5 kPa in the present embodiment as in the first embodiment. As described above, the second valve body 804b functions as a differential pressure valve that is opened/closed according to a pressure difference between an upstream and a downstream.

As described above, in the closed state of the second valve 800b, the second valve body 804b comes into contact with the inner wall 524fi of the valve body proximal end portion 524b. In addition, in the open state of the second valve 800b, the second valve body 804b is separated from the inner wall 524fi of the valve body proximal end portion 524b. The second valve 800b is opened by the second valve body 804b that is separated from the inner wall 524fi, when the pressure difference ΔP is equal to or greater than the predetermined value P1 in the release process period or other periods.

When the ink replenishment container 200b from which the cap 600b is removed is inserted into an ink introduction member 710, the first valve body 520b is pressed toward the second direction D2 by the ink introduction member 710, and thus the first valve body 520b is separated from the first sealing portion 516. As a result, a gap is formed between the first valve body 520b and the first sealing portion 516, and the gap functions as a part of the internal flow path 410. Therefore, even if the second valve 800b is in the closed state, the ink can be replenished from the ink replenishment container 200b to an ink tank 700.

According to the third embodiment, the same effects are achieved in terms of having the same configuration as each of the embodiments described above. In addition, according to the third embodiment, the second valve 800b is closed when the pressure difference ΔP is less than the predetermined value P1 in a period from the mounted state of the cap 600b to completion of the opening, which includes the release process period. As a result, it is possible to suppress the ink from reaching an inside of the sealing member 510 positioned closer to the outlet 460 than the first sealing portion 516. Therefore, since it is possible to suppress the sealing member 510 from being wet with the ink, it is possible to suppress the ink from leaking from the outlet 460 even when the cap 600b is opened in a state where the outlet 460 is directed in a horizontal direction, an obliquely downward direction, or a downward direction. Therefore, it is possible to suppress the occurrence of ink stain. Further, in the sealed state of the cap 600b, it is not necessary to provide the cap 600b with a protrusion for opening the first valve 500b, and thus a structure of the cap 600b can be simplified. Further, since the first valve 500b is not opened by the protrusion during the storage of the ink replenishment container 200b on which the cap 600b is mounted, it is possible to suppress the decrease in a biasing force of the elastic member 530. Further, according to the third embodiment, the first valve body 520b has the communication hole 513, and the second valve 800b is opened when the pressure difference ΔP is equal to or greater than the predetermined value P1, so that a pressurized state of an upstream of the second valve 800b can be easily eliminated.

### D. Fourth Embodiment

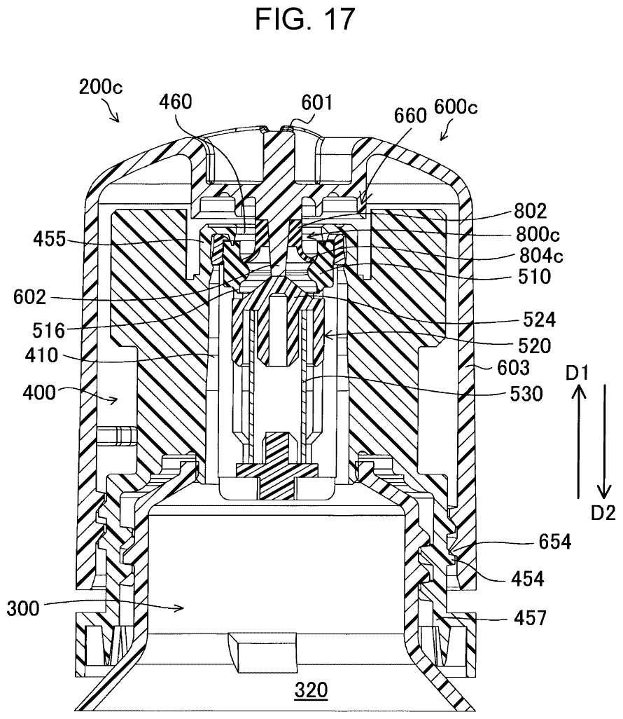

FIG. 17 is a view for explaining an ink replenishment container 200c of a fourth embodiment. FIG. 17 is a partial cross-sectional view of the ink replenishment container 200c, and shows a state at a predetermined timing in an opening operation process of a cap 600c. In addition, in the state illustrated in FIG. 17, a gap is formed between a female screw portion 654 and a male screw portion 454, and an inside of the cap 600c communicates with atmosphere via the gap. In addition, in the state illustrated in FIG. 17, an outlet sealing portion 660 is separated from a distal end portion 455, and is in a released state where the sealing of an outlet 460 is released. A difference between the ink replenishment container 200c and the ink replenishment container 200 of the first embodiment illustrated in FIG. 9 is a second valve body 804c of the second valve 800c. Specifically, in the closed state of the second valve 800c, the second valve body 804c comes into contact only with a sealing member 510. That is, the second valve body 804c does not come into contact with the distal end portion 455. Other configurations of the ink replenishment container 200c of the fourth embodiment are the same as those of the ink replenishment container 200 of the first embodiment, and the same configurations will be denoted by the same reference numerals, and the description thereof will be appropriately omitted.

According to the fourth embodiment, the same effects are achieved in terms of having the same configuration as each of the embodiments described above. In addition, according to the fourth embodiment, the second valve body 804c and the sealing member 510 come into contact with each other in a one-to-one relationship, and the second valve body 804c does not come into contact with a plurality of members having different materials, and thus the second valve 800c can perform a stable opening/closing operation. Therefore, when a pressure difference ΔP is equal to or greater than a predetermined value P1, the second valve 800c can be in the open state more stably. In addition, when the second valve body 804c comes into contact with the sealing member 510 and the distal end portion 455 of an ink outlet-forming portion 400, a one-to-two relationship thereof is established, and a plurality of types of materials that come into contact with the second valve body 804c are provided. On the other hand, in the above embodiment, since the second valve body 804c comes into contact only with the sealing member 510, a sealing property can be more reliably ensured.

### E. Fifth Embodiment

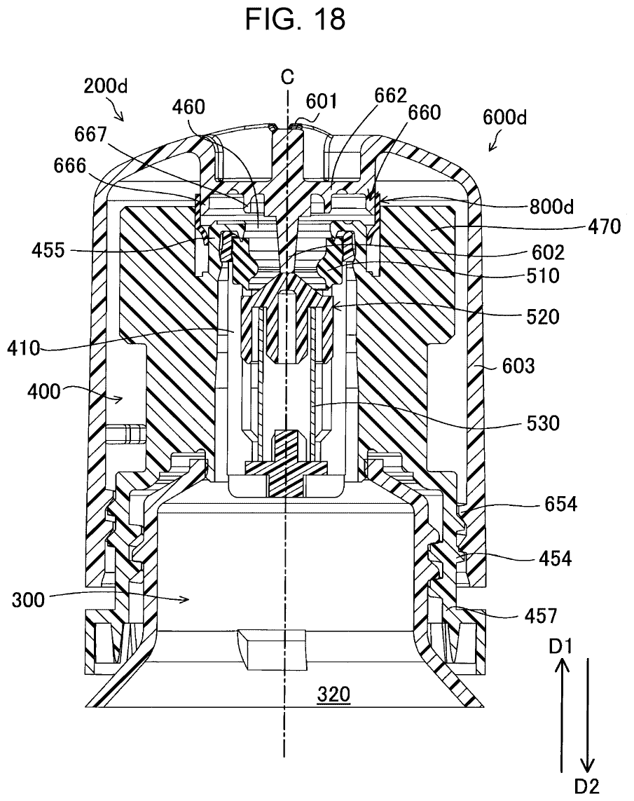

FIG. 18 is a view for explaining an ink replenishment container 200d of a fifth embodiment. FIG. 18 is a partial cross-sectional view of the ink replenishment container 200d, and shows a state at a predetermined timing in an opening operation process of a cap 600d. In addition, in the state illustrated in FIG. 18, a gap is formed between a female screw portion 654 and a male screw portion 454, and an inside of the cap 600d communicates with atmosphere via the gap. In addition, in the state illustrated in FIG. 18, an outlet sealing portion 660 is separated from a distal end portion 455, and is in a released state where the sealing of an outlet 460 is released. A difference between the ink replenishment container 200d and the ink replenishment container 200 of the first embodiment illustrated in FIG. 9 is the configuration and the disposition position of the second valve 800d. Other configurations of the ink replenishment container 200d of the fifth embodiment are the same as those of the ink replenishment container 200 of the first embodiment, and the same configurations will be denoted by the same reference numerals, and the description thereof will be appropriately omitted.

The second valve 800d is a substantially tubular member. The second valve 800d is formed of, for example, a rubber member such as an elastomer having rubber elasticity. The second valve 800d is press-fitted to an outer peripheral surface of a first peripheral wall 666 of the outlet sealing portion 660, and is thus disposed in contact with an outer peripheral surface of the outlet sealing portion 660 over a circumferential direction. That is, the second valve 800d is disposed inside the cap 600d. In order to suppress the second valve 800d from being removed from the outlet sealing portion 660, it is preferable that the outer peripheral surface of the outlet sealing portion 660 is provided with a protrusion portion or an uneven portion.

The second valve 800d is closed by coming into contact with an outer peripheral surface of the distal end portion 455 over the circumferential direction on a side opposite to a side attached to the outlet sealing portion 660, when a pressure difference ΔP, which will be described later, is less than a predetermined value P1. Since the second valve 800d is disposed to couple the outer peripheral surface of the first peripheral wall 666 of the outlet sealing portion 660 and the distal end portion 455, it can be said that the second valve 800d is positioned between an ink accommodation chamber 320 and a bottom wall 662 of the outlet sealing portion 660 in an axial direction. In addition, the second valve 800d and the protrusion portion 470 are disposed at a distance from each other, and a gap between the second valve 800d and a protrusion portion 470 allows a fluid to flow therethrough.

The second valve 800d is disposed to surround the outer peripheral surface of the distal end portion 455. Therefore, an end portion of the second valve 800d close to the distal end portion 455 preferably has an inclined surface for increasing an inner diameter of the second valve 800d close to the distal end portion, such as a C surface, in order to easily insert the distal end portion 455 into the second valve 800d.

The second valve 800d controls a communication state of a fluid flow path that provides communication between the outlet 460 and a gap between a female screw portion 654 and a male screw portion 454. The gap between the female screw portion 654 and the male screw portion 454, which is formed in a process of an opening operation of the cap 600d, functions as an atmospheric communication portion that provides communication between an inside of the cap 600d and an outside of the cap 600d. The second valve 800d is a differential pressure valve that is opened when a pressure difference ΔP between regions with the second valve 800d interposed therebetween is equal to or greater than a predetermined value P1. Specifically, in a flowing direction of the fluid from the outlet 460 to the atmospheric communication portion, when a pressure difference ΔP between a first pressure in a space on an upstream of the second valve 800d and a second pressure in a space on a downstream of the second valve 800d is equal to or greater than a predetermined value P1, the second valve 800d is opened. Specifically, when the first pressure is higher than the second pressure by the predetermined value P1 or greater, the second valve 800d is opened. The opening of the second valve 800d is performed by deforming the second valve 800d radially outward such that the second valve 800d is separated from the outer peripheral surface of the distal end portion 455. The predetermined value P1 is, for example, in a range of 3 kPa or greater and 8 kPa or less, and is 5 kPa in the present embodiment.

As in the first embodiment, the first valve body 520 is formed to be movable in the axial direction, and is disposed in an ink outlet-forming portion 400 to be contactable with or separable from the first sealing portion 516. In addition, as in the first embodiment, the elastic member 530 biases the first valve body 520 toward the first sealing portion 516 in a first direction D1, and brings the first valve body 520 into contact with the first sealing portion 516.

As in the first embodiment, in the sealed state of the cap 600d in which the outlet 460 is sealed by the outlet sealing portion 660, a center protrusion 602 of the cap 600d presses the first valve body 520 in a second direction D2 to form a gap between the first sealing portion 516 and the first valve body 520, thereby opening the first valve 500.

In the sealed state of the cap 600d, the second valve 800d is closed by coming into contact with the outer peripheral surface of the distal end portion 455 when the pressure difference ΔP is less than the predetermined value P1. In addition, in a release process period of the cap 600d from the sealed state to a state where the sealed state is released, when the pressure difference ΔP is less than the predetermined value P1, the second valve 800d is closed. In the release process period, the first valve 500 maintains the open state by the center protrusion 602. In particular, in the present embodiment, when the pressure difference ΔP is less than the predetermined value P1 in a predetermined period, which is a period in which the first valve 500 maintains the open state by the center protrusion 602, the second valve 800d maintains the closed state. The release process period is a part of the predetermined period.

According to the fifth embodiment, the same effects are achieved in terms of having the same configuration as each of the embodiments described above. In addition, according to the fifth embodiment, since the second valve 800d can be disposed further downstream as compared with the first to fourth embodiments, the volume of the space on the upstream of the second valve 800d can be increased. As a result, for example, when the outlet 460 is directed downward and the cap 600d is opened, even when the ink flows toward the cap 600d due to the weight of the ink, more ink can be received in the space on the upstream of the second valve 800d. Therefore, it is possible to further suppress the ink from leaking to the outside of the cap 600d. Further, according to the fifth embodiment, the second valve 800d is disposed in the cap 600d while coming into contact with the outer peripheral surface of the outlet sealing portion 660, so that the volume of the closed space from the ink accommodation chamber 320 to the second valve 800d can be increased. In the release process period, when the pressure difference ΔP is less than the predetermined value P1, the release process is progressed while maintaining the closed state of the second valve 800d, so that the second valve 800d is displaced in the first direction D1. As a result, since the volume of the closed space can be further expanded, the pressure in the closed space is further reduced. Therefore, the ink is more easily sucked to an inner side of the ink replenishment container 200d when the sealing of the cap 600d is released. Thus, it is possible to further suppress the ink from leaking to the outside.

### F. Other Embodiments

### F-1: Other Embodiment 1

In each of the embodiments described above, the male screw portions 454 to which the female screw portions 654 of the caps 600 to 600d are screwed are formed on the outer surface of the ink outlet-forming portions 400 and 400b, but may be formed on the outer surface of the container main body portion 300.

### F-2: Other Embodiment 2

According to the first embodiment, in the closed state of the second valve 800 within the release process period, the second valve body 804 comes into contact with the sealing member 510 as illustrated in FIG. 9, or comes into contact across the sealing member 510 and the distal end portion 455 as illustrated in FIG. 11. Alternatively, in the closed state of the second valve 800 within the release process period, the second valve body 804 may come into contact with only the distal end portion 455, which is a member having rigidity, or may come into contact with only the sealing member 510, which is a member having elasticity. For example, when the second valve body 804 comes into contact with the distal end portion 455 having rigidity, the contact is not too tight as compared when the second valve body 804 comes into contact with a member formed of rubber or the like, and the opening/closing operation of the second valve 800 can be smoothly performed. Further, since the distal end portion 455 has rigidity, the dimension of the distal end portion 455 can be easily managed, and thus the contact and separation between the second valve 800 and the distal end portion 455 can be accurately performed.

### F-3: Other Embodiment 3

In each of the embodiments described above, the ink outlet-forming portions 400 and 400b are separate from the container main body portion 300, but may be integrated with the container main body portion 300.

### F-4: Other Embodiment 4

The second valves 800 and 800a to 800d of each of the embodiments may be mounted on the ink replenishment container in a plurality of combinations. For example, the ink replenishment container 200 of the first embodiment may have the second valve 800d illustrated in FIG. 18 of the fifth embodiment in addition to the second valve 800. Since the ink replenishment container 200 has a plurality of second valves 800 and 800d, for example, even when the cap 600 is not correctly mounted on the ink outlet-forming portion 400 and the cap 600 is in a half-open state, the plurality of second valves 800 and 800d can reduce the possibility that the ink in the ink accommodation chamber 320 leaks to the outside.

### G. Other Aspects

The present disclosure is not limited to the embodiments described above and can be implemented in various aspects without departing from the gist of the present disclosure. For example, the present disclosure can also be implemented by the following aspects. The technical features in each of the embodiments described above corresponding to the technical features in each of aspects described below may be replaced or combined as appropriate in order to solve a part or all of the problems which the present disclosure includes or to accomplish a part or all of the effects which the present disclosure achieves. In addition, unless the technical features are described as essential in the present specification, the technical features can be deleted as appropriate.

1. According to an aspect of the present disclosure, there is provided an ink replenishment container for replenishing ink to a printer via an ink introduction member disposed in the printer. The ink replenishment container includes: a container main body portion having an ink accommodation chamber; an ink outlet-forming portion having an outlet facing an outside, the ink outlet-forming portion connected to the container main body portion and having an internal flow path that provides fluid communication between the outlet and the ink accommodation chamber; a cap having an outlet sealing portion that seals the outlet by being engaged with the ink outlet-forming portion; a first valve disposed inside the ink outlet-forming portion to control a communication state of the internal flow path, the first valve being closed as being biased by an elastic member in a first direction from an ink accommodation chamber side toward the outlet and being opened by the ink introduction member that is inserted from the outlet in a second direction opposite to the first direction against the biasing; and a second valve disposed in at least one of an inside of the ink outlet-forming portion including the outlet and an inside of the cap, the second valve being positioned between the ink accommodation chamber and the outlet sealing portion, in which the second valve is a differential pressure valve that is opened when a pressure difference between a pressure in a space on the ink accommodation chamber side of the second valve and a pressure in a space on an outlet sealing portion side of the second valve is equal to or greater than a predetermined value.

According to the above aspect, the second valve, which is a differential pressure valve, is disposed between the ink accommodation chamber and the outlet sealing portion, so that when the pressure difference between the pressure in the space on the ink accommodation chamber side of the second valve and the pressure in the space on the outlet sealing portion side of the second valve is less than the predetermined value, the second valve is closed. As a result, even when the sealed state of the cap is released in any posture of the ink replenishment container, it is possible to suppress the ink from leaking to a downstream, that is, an outer side of the second valve. Therefore, it is possible to suppress the occurrence of ink stain. In the present embodiment, the downstream or the upstream, which is paired with the downstream, is based on the flowing direction of the fluid when the fluid flows from the ink accommodation chamber to the outside of the cap. In addition, when the ink replenishment container after use is collected, even if the cap is in a state of incompletely sealing the outlet, it is difficult for the ink to leak downstream of the second valve. As a result, it is possible to suppress the occurrence of ink stain even when the ink replenishment container is collected. In addition, for example, when the sealing of the cap is released in a posture in which the outlet is directed upward, the second valve is opened when the pressure difference is equal to or greater than the predetermined value. As a result, even when the pressure in the ink accommodation chamber increases due to temperature change or pressure change, the air in the ink accommodation chamber can flow out of the ink replenishment container via the second valve. Therefore, a pressurized state of the ink accommodation chamber can be easily eliminated.

2. In the above aspect, in a release process period from a sealed state of the cap, in which the outlet is sealed, to a state where the sealed state is released, when the pressure difference is less than the predetermined value, the second valve may be in a closed state.

According to the above aspect, even if the first valve is in the open state, the second valve is in the closed state when the pressure difference is less than the predetermined value, so that it is possible to suppress the ink from flowing out of the downstream of the second valve.

3. In the above aspect, the first valve may be a valve that performs opening/closing between a sealing member disposed in a distal end portion of the ink outlet-forming portion and a first valve body positioned on the second direction side from the sealing member and biased by the elastic member, the second valve may have a second valve body disposed in the cap, in a sealed state of the cap in which the outlet is sealed, when the pressure difference is less than the predetermined value, the second valve body may be in a closed state by coming into contact with another member, which is at least one of the sealing member and the distal end portion of the ink outlet-forming portion, in a release process period from the sealed state to a state where the sealed state is released, when the pressure difference is less than the predetermined value, the first valve may maintain an open state and the second valve may maintain a closed state, and in a released state where the sealed state is released with the first valve being in a closed state, the second valve may be separated from the other member.

According to the above aspect, in the release process period, when the pressure difference is less than the predetermined value, the release process is progressed while maintaining the closed state of the second valve, so that the second valve is displaced in the first direction. As a result, the volume of the closed space from the ink accommodation chamber to the second valve is expanded. As the volume of the closed space is expanded, a pressure of the closed space is reduced, so that the ink is easily sucked to the inner side of the ink outlet-forming portion when the sealing of the cap is released. Thus, it is possible to further suppress the ink from leaking to the outside. In addition, in a state where the sealed state of the cap is released and in the closed state of the first valve, the second valve is in the open state while being separated from the other member. However, since the first valve is in the closed state, it is possible to suppress the ink from leaking to the downstream of the first valve. In addition, since the second valve body is disposed in the cap, the second valve body can be replaced together with the cap, such as when the second valve body is deteriorated.

4. In the above aspect, the distal end portion of the ink outlet-forming portion may have rigidity, and the second valve body may have elasticity, and in the closed state of the second valve, the second valve body may be in contact with the distal end portion.

According to the above aspect, since the second valve body comes into contact with the distal end portion having rigidity, the contact is not too tight as compared when the second valve body comes into contact with a member formed of rubber or the like, and the opening/closing operation of the second valve body can be smoothly performed. Further, since the distal end portion has rigidity, the dimension of the distal end portion can be easily managed.

5. In the above aspect, the second valve body may have elasticity, and in the closed state of the second valve, the second valve body may be in contact only with the sealing member.

According to the above aspect, the second valve body and the sealing member come into contact with each other in a one-to-one relationship, and the second valve body does not come into contact with a plurality of members having different materials, and thus the second valve can perform a stable opening/closing operation. Therefore, when a pressure difference is equal to or greater than a predetermined value, the second valve can be in the open state more stably. In addition, when the second valve body comes into contact with the sealing member and the distal end portion of an ink outlet-forming portion, a one-to-two relationship thereof is established, and a plurality of types of materials that come into contact with the second valve body are provided. On the other hand, in the above aspect, since the second valve body comes into contact only with the sealing member, a sealing property can be more reliably ensured.

6. In the above aspect, the first valve may have a first valve body, the second valve may have a second valve body and may be disposed in the ink outlet-forming portion, the ink replenishment container may further includes a sealing member disposed in a distal end portion having the outlet, a first opening/closing portion of the first valve may be a part at which the first valve body is in contact with or is separated from a first sealing portion disposed at an end in the second direction of the sealing member, and a second opening/closing portion of the second valve may be a part which is positioned on the first direction side from the first opening/closing portion of the first valve and at which the first valve body may come into contact with or be separated from the second valve body.

According to the above aspect, since the second valve can suppress the ink from flowing out of a space in an ink outlet-forming portion that is provided on a downstream of the part in which the second valve body comes into contact with the first valve body, it is possible to suppress the ink from dripping from the outlet even when the cap is removed by allowing the outlet to be directed downward or the like. Therefore, it is possible to suppress the occurrence of ink stain.

7. In the above aspect, the ink outlet-forming portion may have the outlet, a central shaft, and a distal end portion that defines an opening of the outlet at a distal end of the ink outlet-forming portion, a male screw portion may be formed at an outer surface of at least one of the container main body portion and the ink outlet-forming portion, the cap may further includes a top wall, a tubular side wall coupled to the top wall, a center protrusion protruding downward from a center portion of the top wall when the top wall is positioned on the side wall, and a female screw portion disposed on an inner peripheral surface of the side wall, the first valve may include: a sealing member disposed in the distal end portion and having a first sealing portion at an end in the second direction of the sealing member; a first valve body disposed in the ink outlet-forming portion configured to come into contact with or to be separated from the first sealing portion; and the elastic member that biases the first valve body in the first direction toward the first sealing portion, and brings the first valve body into contact with the first sealing portion, the second valve may be disposed in the cap in contact with an outer peripheral surface of the outlet sealing portion, and may be closed while in contact with an outer peripheral surface of the distal end portion in a sealed state of the cap in which the outlet is sealed, in the sealed state of the cap, the center protrusion may press the first valve body in the second direction to form a gap between the first sealing portion and the first valve body, so that the first valve may be opened, and in a release process period of the cap from the sealed state to a state where the sealed state is released, when the pressure difference is less than the predetermined value, the second valve may be closed.

According to the above aspect, since the second valve can be disposed further downstream, the volume of the space on the upstream of the second valve can be increased. As a result, for example, when the outlet is directed downward and the cap is opened, even when the ink flows toward the cap due to the weight of the ink, more ink can be received in the space on the upstream of the second valve. Therefore, it is possible to further suppress the ink from leaking to the outside of the cap. Further, according to the above aspect, the second valve is disposed in the cap in contact with the outer peripheral surface of the outlet sealing portion so that the volume of the closed space from the ink accommodation chamber to the second valve is increased, and thus the volume of the closed space can be expanded in the release process period. As a result, the pressure in the closed space is further reduced, so that the ink is more easily sucked to an inner side of the ink replenishment container when the sealing of the cap is released. Thus, it is possible to further suppress the ink from leaking to the outside.

8. In the above aspect, the first valve may include: a sealing member disposed in a tubular distal end portion of the ink outlet-forming portion having the outlet, and having a first sealing portion disposed at an end in the second direction of the sealing member; a first valve body disposed in the ink outlet-forming portion, the first valve body configured to be in contact with or to be separated from the first sealing portion, and the first valve body having a communication hole for forming a part of the internal flow path; and the elastic member that biases the first valve body in the first direction toward the first sealing portion to bring the first valve body into contact with the first sealing portion, and the second valve may include a second valve body as a differential pressure valve disposed on the second direction side from the first sealing portion in the internal flow path.

According to the above aspect, since the first valve is closed in the release process period, and the second valve is also closed when the pressure difference is less than the predetermined value, it is possible to suppress the ink from reaching an inside of the sealing member closer to the outlet than the first sealing portion. Therefore, since it is possible to suppress the sealing member from being wet with the ink, it is possible to suppress the ink from leaking from the outlet even when the cap is opened in a state where the outlet is directed in a horizontal direction, an obliquely downward direction, or a downward direction. Therefore, it is possible to suppress the occurrence of ink stain. Further, in the sealed state of the cap, it is not necessary to provide the cap with a protrusion for opening the first valve, and thus a structure of the cap can be simplified. Further, since the first valve is not opened by the protrusion during the storage of the ink replenishment container on which the cap is mounted, it is possible to suppress the decrease in a biasing force of the elastic member.

9. In the above aspect, in a closed state of the second valve, the second valve body may be in contact with an inner wall of the first valve body, and in an open state of the second valve, the second valve body may be separated from the inner wall, and in a release process period from a sealed state of the cap, in which the outlet is sealed, to a state where the sealed state is released, the first valve body may maintain contact with the first sealing portion, and when the pressure difference is equal to or greater than the predetermined value, the second valve body may be opened as the second valve body is separated from the inner wall.

According to the above aspect, the second valve is opened when the pressure difference is equal to or greater than the predetermined value, so that a pressurized state of an upstream of the second valve can be easily eliminated.

The present disclosure can also be implemented in various other forms. For example, the present disclosure can be implemented in the form such as a method for manufacturing an ink replenishment container.

What is claimed is:

1. An ink replenishment container for replenishing ink to a printer via an ink introduction member disposed in the printer, comprising:
a container main body portion having an ink accommodation chamber;
an ink outlet-forming portion having an outlet facing an outside, the ink outlet-forming portion connected to the container main body portion and having an internal flow path that provides fluid communication between the outlet and the ink accommodation chamber;
a cap having an outlet sealing portion that seals the outlet by being engaged with the ink outlet-forming portion;
a first valve disposed inside the ink outlet-forming portion to control a communication state of the internal flow path, the first valve being closed as being biased by an elastic member in a first direction from an ink accommodation chamber side toward the outlet and being opened by the ink introduction member that is inserted from the outlet in a second direction opposite to the first direction against the biasing; and
a second valve disposed in at least one of an inside of the ink outlet-forming portion including the outlet and an inside of the cap, the second valve being positioned between the ink accommodation chamber and the outlet sealing portion, wherein
the second valve is a differential pressure valve that is opened when a pressure difference between a pressure in a space on the ink accommodation chamber side of the second valve and a pressure in a space on an outlet sealing portion side of the second valve is equal to or greater than a predetermined value.

2. The ink replenishment container according to claim 1, wherein
in a release process period from a sealed state of the cap, in which the outlet is sealed, to a state where the sealed state is released, when the pressure difference is less than the predetermined value, the second valve is in a closed state.

3. The ink replenishment container according to claim 1, wherein
the first valve is a valve that performs opening/closing between a sealing member disposed in a distal end portion of the ink outlet-forming portion and a first valve body positioned on the second direction side from the sealing member and biased by the elastic member,
the second valve has a second valve body disposed in the cap, in a sealed state of the cap in which the outlet is sealed, when the pressure difference is less than the predetermined value, the second valve body is in a closed state by coming into contact with another member, which is at least one of the sealing member and the distal end portion of the ink outlet-forming portion,
in a release process period from the sealed state to a state where the sealed state is released, when the pressure difference is less than the predetermined value, the first valve maintains an open state and the second valve maintains a closed state, and
in a released state where the sealed state is released with the first valve being in a closed state, the second valve is separated from the other member.

4. The ink replenishment container according to claim 3, wherein
the distal end portion of the ink outlet-forming portion has rigidity, and
the second valve body has elasticity, and in the closed state of the second valve, the second valve body is in contact with the distal end portion.

5. The ink replenishment container according to claim 3, wherein
the second valve body has elasticity, and in the closed state of the second valve, the second valve body is in contact only with the sealing member.

6. The ink replenishment container according to claim 1, wherein
the first valve has a first valve body,
the second valve has a second valve body and is disposed in the ink outlet-forming portion,
the ink replenishment container further comprises a sealing member, the sealing member disposed in a distal end portion having the outlet,
a first opening/closing portion of the first valve is a part at which the first valve body is in contact with or is separated from a first sealing portion disposed at an end portion in the second direction of the sealing member,
the second valve body is integrally formed with the sealing member, and
a second opening/closing portion of the second valve is a part which is positioned on the first direction side from the first opening/closing portion of the first valve and at which the first valve body comes into contact with or is separated from the second valve body.

7. The ink replenishment container according to claim 1, wherein
the ink outlet-forming portion has the outlet, a central shaft, and a distal end portion that defines an opening of the outlet at a distal end of the ink outlet-forming portion,
a male screw portion is formed at an outer surface of at least one of the container main body portion and the ink outlet-forming portion,
the cap further includes a top wall, a tubular side wall coupled to the top wall, a center protrusion protruding downward from a center portion of the top wall when the top wall is positioned on the side wall, and a female screw portion disposed on an inner peripheral surface of the side wall,
the first valve includes:
a sealing member disposed in the distal end portion and having a first sealing portion at an end in the second direction of the sealing member;
a first valve body disposed in the ink outlet-forming portion configured to come into contact with or to be separated from the first sealing portion; and
the elastic member that biases the first valve body in the first direction toward the first sealing portion, and brings the first valve body into contact with the first sealing portion,
the second valve is disposed in the cap in contact with an outer peripheral surface of the outlet sealing portion, and is closed while in contact with an outer peripheral surface of the distal end portion in a sealed state of the cap in which the outlet is sealed,
in the sealed state of the cap, the center protrusion presses the first valve body in the second direction to form a gap between the first sealing portion and the first valve body, so that the first valve is opened, and
in a release process period of the cap from the sealed state to a state where the sealed state is released, when the pressure difference is less than the predetermined value, the second valve is closed.

8. The ink replenishment container according to claim 1, wherein
the first valve includes:
a sealing member disposed in a tubular distal end portion of the ink outlet-forming portion having the outlet, and having a first sealing portion disposed at an end in the second direction of the sealing member;
a first valve body disposed in the ink outlet-forming portion, the first valve body configured to be in contact with or to be separated from the first sealing portion, and the first valve body having a communication hole for forming a part of the internal flow path; and
the elastic member that biases the first valve body in the first direction toward the first sealing portion to bring the first valve body into contact with the first sealing portion, and
the second valve includes a second valve body as a differential pressure valve disposed on the second direction side from the first sealing portion in the internal flow path.

9. The ink replenishment container according to claim 8, wherein
in a closed state of the second valve, the second valve body is in contact with an inner wall of the first valve body, and in an open state of the second valve, the second valve body is separated from the inner wall, and
in a release process period from a sealed state of the cap, in which the outlet is sealed, to a state where the sealed state is released,
the first valve body maintains contact with the first sealing portion, and
when the pressure difference is equal to or greater than the predetermined value, the second valve body is opened as the second valve body is separated from the inner wall.
